(19) United States
(12) Patent Application Publication
(10) Pub. No.: US 2016/0212723 A1
(43) Pub. Date: Jul. 21, 2016

(54) SYNCHRONIZATION METHOD AND APPARATUS

(71) Applicant: Huawei Technologies Co., Ltd., Shenzhen (CN)

(72) Inventors: Zhiqin Yu, Shenzhen (CN); Weiliang Zhang, Beijing (CN)

(21) Appl. No.: 15/085,041

(22) Filed: Mar. 30, 2016

Related U.S. Application Data
(63) Continuation of application No. PCT/CN2013/084722, filed on Sep. 30, 2013.

(51) Int. Cl. H04W 56/00; H04W 76/02; H04W 76/04; H04W 72/04

(52) U.S. Cl. CPC H04W 56/0015; H04W 72/0413; H04W 76/023; H04W 76/048

(57) ABSTRACT

Embodiments of the present invention includes: acquiring, by the DS-user terminal, a first timing offset, where the first timing offset is a difference between a start time point of receiving data by the DS-user terminal and a start time point of sending data by a DM-user terminal, the start time point of sending data by the DM-user terminal is a start time point of sending data after the DM-user terminal is synchronized with a network-side device, and the start time point of receiving data by the DM-user terminal is a start time point of receiving data after the DM-user terminal is synchronized with the network-side device; and adjusting, by the DS-user terminal according to the first timing offset, the start time point of receiving data by the DS-user terminal, so as to synchronize with the DM-user terminal and the network-side device.

### CROSS-REFERENCE TO RELATED APPLICATIONS

This application is a continuation of International Application No. PCT/CN2013/084722, filed on Sep. 30, 2013, which is hereby incorporated by reference in its entirety.

### TECHNICAL FIELD

The present invention relates to the communications field, and in particular, to a synchronization method and apparatus.

### BACKGROUND

To expand network coverage, one manner is to expand indoor network coverage by adding a site, which, however, requires a huge investment from an operator; another manner is to communicate in a device-to-device (Device to Device, D2D) manner, namely, one is a master user terminal, and the other is a secondary user terminal, thereby reducing network construction costs of the operator while providing network coverage enhancement.

In an indoor or secluded indoor place, when signal strength of a network is in a state that makes communication impossible, some indoor applications are unable to communicate normally. For example, an application of a smart meter requires a watt-hour meter in a basement to report data to an electric power company periodically over the network. Therefore, network coverage needs to be expanded.

However, without network coverage, an existing technology of synchronization between the user terminal and a network-side device is unable to support a secondary user terminal in completing synchronization with the network-side device.

### SUMMARY

Embodiments of the present invention provide a synchronization method and apparatus, which can support synchronization without network coverage between a device-to-device secondary user terminal (D2D Slave user terminal, DS-user terminal) and a network-side device.

To achieve the foregoing objective, the following technical solutions are used in the embodiments of the present invention:

According to a first aspect, an embodiment of the present invention provides a synchronization method, including:

acquiring, by a device-to-device secondary user terminal DS-user terminal, a first timing offset, where the first timing offset is a difference between a start time point of receiving data by the DS-user terminal and a start time point of sending data by a device-to-device master user terminal DM-user terminal, or is a difference between a start time point of sending data by the DS-user terminal and a start time point of receiving data by a DM-user terminal, the start time point of sending data by the DM-user terminal is a start time point of sending data after the DM-user terminal is synchronized with a network-side device, and the start time point of receiving data by the DM-user terminal is a start time point of receiving data after the DM-user terminal is synchronized with the network-side device; and

adjusting, by the DS-user terminal according to the first timing offset, the start time point of receiving data by the DS-user terminal or the start time point of sending data by the DS-user terminal, so as to synchronize with the DM-user terminal and the network-side device.

In a first possible implementation manner of the first aspect, the acquiring, by a device-to-device secondary user terminal DS-user terminal, a first timing offset includes:

receiving, by the DS-user terminal, a first synchronization signal from the DM-user terminal when communication is performed between the DS-user terminal and the DM-user terminal in a device-to-device D2D manner, where the first synchronization signal is used to synchronize the start time point of receiving data by the DS-user terminal with the start time point of sending data by the DM-user terminal; and

acquiring, by the DS-user terminal, the first timing offset according to the first synchronization signal.

In a second possible implementation manner of the first aspect, before the acquiring, by a device-to-device secondary user terminal DS-user terminal, a first timing offset, the method further includes:

sending, by the DS-user terminal, a second synchronization signal to the DM-user terminal when communication is performed between the DS-user terminal and the DM-user terminal in a D2D manner, so that the DM-user terminal acquires the first timing offset according to the second synchronization signal and sends the first timing offset to the DS-user terminal, where the second synchronization signal is used to synchronize the start time point of sending data by the DS-user terminal with the start time point of receiving data by the DM-user terminal.

With reference to the first possible implementation manner of the first aspect, in a third possible implementation manner, a method used by the DS-user terminal to acquire the first timing offset according to the first synchronization signal includes:

performing, by the DS-user terminal, calculation on the first synchronization signal to obtain a first synchronization peak; and

determining, by the DS-user terminal, the first timing offset according to a time point corresponding to the first synchronization peak.

With reference to the first possible implementation manner or the third possible implementation manner of the first aspect, in a fourth possible implementation manner, the receiving, by the DS-user terminal, a first synchronization signal from the DM-user terminal includes:

receiving, by the DS-user terminal, the first synchronization signal from the DM-user terminal on a preset uplink time-frequency resource.

With reference to the second possible implementation manner of the first aspect, in a fifth possible implementation manner, the acquiring, by a device-to-device secondary user terminal DS-user terminal, a first timing offset includes:

receiving, by the DS-user terminal, the first timing offset from the DM-user terminal on a preset uplink time-frequency resource.

In a sixth possible implementation manner of the first aspect, after the synchronizing, by the DS-user terminal, with the network-side device and the DM-user terminal, the method further includes:

receiving, by the DS-user terminal, a first instruction message from the DM-user terminal, where the first instruction message is sent by the network-side device to the DM-user terminal, the first instruction message is used to instruct that an idle discontinuous reception idle DRX period be changed, and the first instruction message includes a message type and a period value of the idle DRX period;

changing, by the DS-user terminal, the idle DRX period according to the first instruction message; and

sending, by the DS-user terminal, a first response message corresponding to the first instruction message to the DM-user terminal, so that the DM-user terminal sends the first response message to the network-side device, and the network-side device learns, according to the first response message, success in changing the idle DRX period.

With reference to the sixth possible implementation manner of the first aspect, in a seventh possible implementation manner, after the changing, by the DS-user terminal, the idle DRX period according to the first instruction message, the method further includes:

communicating, by the DS-user terminal, with the DM-user terminal according to a changed idle DRX period.

According to a second aspect, an embodiment of the present invention further provides a synchronization method, including:

sending, by a DM-user terminal, a first synchronization signal to a DS-user terminal when communication is performed between the DS-user terminal and the DM-user terminal in a D2D manner, where the first synchronization signal is used by the DS-user terminal to acquire a first timing offset according to the first synchronization signal, the first timing offset is a difference between a start time point of receiving data by the DS-user terminal and a start time point of sending data by the DM-user terminal, and the start time point of sending data by the DM-user terminal is a start time point of sending data after the DM-user terminal is synchronized with a network-side device; and keeping, by the DM-user terminal, synchronization with the DS-user terminal, where the synchronization is specifically that the DS-user terminal adjusts, according to the first timing offset, the start time point of receiving data by the DS-user terminal, so as to synchronize with the DM-user terminal and the network-side device.

In a first possible implementation manner of the second aspect, the sending, by a DM-user terminal, a first synchronization signal to a DS-user terminal includes:

sending, by the DM-user terminal, the first synchronization signal to the DS-user terminal on a preset uplink time-frequency resource.

With reference to the second aspect or the first possible implementation manner of the second aspect, in a second possible implementation manner, after the synchronizing, by the DM-user terminal, with the network-side device and the DS-user terminal, the method further includes:

sending, by the DM-user terminal, a first instruction message to the DS-user terminal, so that the DS-user terminal changes an idle DRX period according to the first instruction message, where the first instruction message is sent by the network-side device to the DM-user terminal, the first instruction message is used to instruct that the idle DRX period be changed, and the first instruction message includes a message type and a period value of the idle DRX period;

receiving, by the DM-user terminal, a first response message that is from the DS-user terminal and corresponding to the first instruction message; and

sending, by the DM-user terminal, the first response message to the network-side device, so that the network-side device learns, according to the first response message, success in changing the idle DRX period.

According to a third aspect, an embodiment of the present invention further provides a synchronization method, including:

receiving, by a DM-user terminal, a synchronization signal from a DS-user terminal when communication is performed between the DS-user terminal and the DM-user terminal in a D2D manner;

acquiring, by the DM-user terminal, a first timing offset according to the synchronization signal received from the DS-user terminal, where the first timing offset is a difference between a start time point of sending data by the DS-user terminal and a start time point of receiving data by the DM-user terminal, and the start time point of receiving data by the DM-user terminal is a start time point of receiving data after the DM-user terminal is synchronized with a network-side device; and

sending, by the DM-user terminal, the first timing offset to the DS-user terminal, where the first timing offset is used by the DS-user terminal to adjust, according to the first timing offset, the start time point of sending data by the DS-user terminal, so as to synchronize with the DM-user terminal and the network-side device.

In a first possible implementation manner of the third aspect, a method used by the DM-user terminal to acquire the first timing offset according to the synchronization signal received from the DS-user terminal includes:

performing, by the DM-user terminal, calculation on the synchronization signal received from the DS-user terminal, so as to obtain a second synchronization peak; and

determining, by the DM-user terminal, the first timing offset according to a time point corresponding to the second synchronization peak.

With reference to the third aspect or the first possible implementation manner of the third aspect, in a second possible implementation manner, the sending, by the DM-user terminal, the first timing offset to the DS-user terminal includes:

sending, by the DM-user terminal, the first timing offset to the DS-user terminal on a preset uplink time-frequency resource.

With reference to the third aspect or either the first possible implementation manner or the second possible implementation manner of the third aspect, in a third possible implementation manner, after the synchronizing, by the DM-user terminal, with the network-side device and the DS-user terminal, the method further includes:

sending, by the DM-user terminal, a first instruction message to the DS-user terminal, so that the DS-user terminal changes an idle DRX period according to the first instruction message, where the first instruction message is sent by the network-side device to the DM-user terminal, the first instruction message is used to instruct that the idle DRX period be changed, and the first instruction message includes a message type and a period value of the idle DRX period;

receiving, by the DM-user terminal, a first response message that is from the DS-user terminal and corresponding to the first instruction message; and

sending, by the DM-user terminal, the first response message to the network-side device, so that the network-side device learns, according to the first response message, success in changing the idle DRX period.

According to a fourth aspect, an embodiment of the present invention provides a user terminal, including:

an acquiring unit, configured to acquire a first timing offset, where the first timing offset is a difference between a start time point of receiving data by the user terminal and a start time point of sending data by a DM-user terminal, or is a difference between a start time point of sending data by the user terminal and a start time point of receiving data by a DM-user terminal, the start time point of sending data by the DM-user terminal is a start time point of sending data after the DM-user terminal is synchronized with a network-side device, and the start time point of receiving data by the DM-user terminal is a start time point of receiving data after the DM-user terminal is synchronized with the network-side device; and

a processing unit, configured to: according to the first timing offset acquired by the acquiring unit, adjust the start time point of receiving data by the user terminal or the start time point of sending data by the user terminal, so as to synchronize with the DM-user terminal and the network-side device.

In a first possible implementation manner of the fourth aspect, the user terminal further includes a receiving unit;

the receiving unit is configured to receive a first synchronization signal from the DM-user terminal when communication is performed between the user terminal and the DM-user terminal in a D2D manner, where the first synchronization signal is used to synchronize the start time point of receiving data by the user terminal with the start time point of sending data by the DM-user terminal; and

the acquiring unit is specifically configured to acquire the first timing offset according to the first synchronization signal received by the receiving unit, where the first synchronization signal is used to synchronize the start time point of receiving data by the user terminal with the start time point of sending data by the DM-user terminal.

In a second possible implementation manner of the fourth aspect, the user terminal further includes a sending unit, and

the sending unit is configured to, before the acquiring unit acquires the first timing offset, send a synchronization signal to the DM-user terminal when communication is performed between the user terminal and the DM-user terminal in a D2D manner, so that the DM-user terminal acquires the first timing offset according to the second synchronization signal and sends the first timing offset to the user terminal, where the second synchronization signal is used to synchronize the start time point of sending data by the user terminal with the start time point of receiving data by the DM-user terminal.

With reference to the first possible implementation manner of the fourth aspect, in a third possible implementation manner,

the acquiring unit is specifically configured to perform calculation on the first synchronization signal received by the receiving unit, so as to obtain a first synchronization peak; and determine the first timing offset according to a time point corresponding to the first synchronization peak.

With reference to the first possible implementation manner or the third possible implementation manner of the fourth aspect, in a fourth possible implementation manner,

the receiving unit is specifically configured to receive the first synchronization signal from the DM-user terminal on a preset uplink time-frequency resource.

With reference to the second possible implementation manner of the fourth aspect, in a fifth possible implementation manner, the acquiring unit is specifically configured to receive the first timing offset from the DM-user terminal on a preset uplink time-frequency resource.

In a sixth possible implementation manner of the fourth aspect, the user terminal further includes a sending unit and a receiving unit;

the receiving unit is configured to receive a first instruction message from the DM-user terminal after the user terminal is synchronized with the network-side device and the DM-user terminal, where the first instruction message is sent by the network-side device to the DM-user terminal, the first instruction message is used to instruct that an idle DRX period be changed, and the first instruction message includes a message type and a period value of the idle DRX period;

the processing unit is further configured to change the idle DRX period according to the first instruction message received by the receiving unit; and

the sending unit is configured to send a first response message, which is corresponding to the first instruction message received by the receiving unit, to the DM-user terminal, so that the DM-user terminal sends the first response message to the network-side device, and the network-side device learns, according to the first response message, success in changing the idle DRX period.

With reference to the sixth possible implementation manner of the fourth aspect, in a seventh possible implementation manner,

the processing unit is further configured to communicate with the DM-user terminal according to a changed idle DRX period.

According to a fifth aspect, an embodiment of the present invention further provides a user terminal, including:

a sending unit, configured to send a first synchronization signal to a DS-user terminal when communication is performed between the DS-user terminal and the user terminal in a D2D manner, where the first synchronization signal is used by the DS-user terminal to acquire a first timing offset according to the first synchronization signal, the first timing offset is a difference between a start time point of receiving data by the DS-user terminal and a start time point of sending data by the user terminal, and the start time point of sending data by the user terminal is a start time point of sending data after the user terminal is synchronized with a network-side device; and

a keeping unit, configured to keep synchronization with the DS-user terminal, where the synchronization is specifically that the DS-user terminal adjusts, according to the first timing offset, the start time point of receiving data by the DS-user terminal, so as to synchronize with the user terminal and the network-side device.

In a first possible implementation manner of the fifth aspect,

the sending unit is specifically configured to send the first synchronization signal to the DS-user terminal on a preset uplink time-frequency resource.

With reference to the fifth aspect or the first possible implementation manner of the fifth aspect, in a second possible implementation manner, the user terminal further includes a receiving unit;

the sending unit is further configured to send a first instruction message to the DS-user terminal after the user terminal is synchronized with the network-side device and the DS-user terminal, so that the DS-user terminal changes an idle DRX period according to the first instruction message, where the first instruction message is sent by the network-side device to the user terminal, the first instruction message is used to instruct that the idle DRX period be changed, and the first instruction message includes a message type and a period value of the idle DRX period;

the receiving unit is configured to receive a first response message that is from the DS-user terminal and corresponding to the first instruction message sent by the sending unit; and

the sending unit is further configured to send the first response message, which is received by the receiving unit, to the network-side device, so that the network-side device learns, according to the first response message, success in changing the idle DRX period.

According to a sixth aspect, an embodiment of the present invention further provides a user terminal, including:

a receiving unit, configured to receive a synchronization signal from a DS-user terminal when communication is performed between the DS-user terminal and the user terminal in a D2D manner;

an acquiring unit, configured to acquire a first timing offset according to the synchronization signal received by the receiving unit from the DS-user terminal, where the first timing offset is a difference between a start time point of sending data by the DS-user terminal and a start time point of receiving data by the user terminal, and the start time point of receiving data by the user terminal is a start time point of receiving data after the user terminal is synchronized with a network-side device; and

a sending unit, configured to send the first timing offset, which is acquired by the acquiring unit, to the DS-user terminal, where the first timing offset is used by the DS-user terminal to adjust, according to the first timing offset, the start time point of sending data by the DS-user terminal, so as to synchronize with the user terminal and the network-side device.

In a first possible implementation manner of the sixth aspect,

the acquiring unit is specifically configured to perform calculation on the synchronization signal received by the receiving unit from the DS-user terminal, so as to obtain a second synchronization peak; and determine the first timing offset according to a time point corresponding to the second synchronization peak.

With reference to the sixth aspect or the first possible implementation manner of the sixth aspect, in a second possible implementation manner,

the sending unit is specifically configured to send the first timing offset, which is acquired by the acquiring unit, to the DS-user terminal on a preset uplink time-frequency resource.

With reference to the sixth aspect or either the first possible implementation manner or the second possible implementation manner of the sixth aspect, in a third possible implementation manner,

the sending unit is further configured to send a first instruction message to the DS-user terminal after the user terminal is synchronized with the network-side device and the DS-user terminal, so that the DS-user terminal changes an idle DRX period according to the first instruction message, where the first instruction message is sent by the network-side device to the user terminal, the first instruction message is used to instruct that the idle DRX period be changed, and the first instruction message includes a message type and a period value of the idle DRX period;

the receiving unit is further configured to receive a first response message that is from the DS-user terminal and corresponding to the first instruction message sent by the sending unit; and

the sending unit is further configured to send the first response message, which is received by the receiving unit, to the network-side device, so that the network-side device learns, according to the first response message, success in changing the idle DRX period.

According to a seventh aspect, an embodiment of the present invention further provides a user terminal, including:

a processor, configured to acquire a first timing offset, and adjust, according to the first timing offset, a start time point of receiving data by the user terminal or a start time point of sending data by the user terminal, so as to synchronize with a DM-user terminal and a network-side device, where the first timing offset is a difference between a start time point of receiving data by the user terminal and a start time point of sending data by the DM-user terminal, or is a difference between a start time point of sending data by the user terminal and a start time point of receiving data by a DM-user terminal, the start time point of sending data by the DM-user terminal is a start time point of sending data after the DM-user terminal is synchronized with the network-side device, and the start time point of receiving data by the DM-user terminal is a start time point of receiving data after the DM-user terminal is synchronized with the network-side device.

In a first possible implementation manner of the seventh aspect, the user terminal further includes a receiver;

the receiver is configured to receive a first synchronization signal from the DM-user terminal when communication is performed between the user terminal and the DM-user terminal in a D2D manner, where the first synchronization signal is used to synchronize the start time point of receiving data by the user terminal with the start time point of sending data by the DM-user terminal; and

the processor is specifically configured to acquire the first timing offset according to the first synchronization signal received by the receiver.

In a second possible implementation manner of the seventh aspect, the user terminal further includes a sender, and

the sender is configured to, before the processor acquires the first timing offset, send a second synchronization signal to the DM-user terminal when communication is performed between the user terminal and the DM-user terminal in a D2D manner, so that the DM-user terminal acquires the first timing offset according to the second synchronization signal and sends the first timing offset to the user terminal, where the second synchronization signal is used to synchronize the start time point of sending data by the user terminal with the start time point of receiving data by the DM-user terminal.

With reference to the first possible implementation manner of the seventh aspect, in a third possible implementation manner,

the processor is specifically configured to perform calculation on the first synchronization signal received by the receiver, so as to obtain a first synchronization peak; and determine the first timing offset according to a time point corresponding to the first synchronization peak.

With reference to the first possible implementation manner or the third possible implementation manner of the seventh aspect, in a fourth possible implementation manner,

the receiver is specifically configured to receive the first synchronization signal from the DM-user ten Anal on a preset uplink time-frequency resource.

With reference to the second possible implementation manner of the seventh aspect, in a fifth possible implementation manner, the user terminal further includes a receiver, and

the receiver is configured to receive the first timing offset from the DM-user terminal on a preset uplink time-frequency resource.

In a sixth possible implementation manner of the seventh aspect, the user terminal further includes a sender and a receiver;

the receiver is configured to receive a first instruction message from the DM-user terminal after the user terminal is synchronized with the network-side device and the DM-user terminal, where the first instruction message is sent by the network-side device to the DM-user terminal, the first instruction message is used to instruct that an idle DRX period be changed, and the first instruction message includes a message type and a period value of the idle DRX period;

the processor is further configured to change the idle DRX period according to the first instruction message received by the receiver; and

the sender is configured to send a first response message, which is corresponding to the first instruction message received by the receiver, to the DM-user terminal, so that the DM-user terminal sends the first response message to the network-side device, and the network-side device learns, according to the first response message, success in changing the idle DRX period.

With reference to the sixth possible implementation manner of the seventh aspect, in a seventh possible implementation manner,

the processor is further configured to communicate with the DM-user terminal according to a changed idle DRX period.

According to an eighth aspect, an embodiment of the present invention further provides a user terminal, including:

a sender, configured to send a first synchronization signal to a DS-user terminal when communication is performed between the DS-user terminal and the user terminal in a D2D manner, where the first synchronization signal is used by the DS-user terminal to acquire a first timing offset according to the first synchronization signal, the first timing offset is a difference between a start time point of receiving data by the DS-user terminal and a start time point of sending data by the user terminal, and the start time point of sending data by the user terminal is a start time point of sending data after the user terminal is synchronized with a network-side device; and

a processor, configured to keep synchronization with the DS-user terminal, where the synchronization is specifically that the DS-user terminal adjusts, according to the first timing offset, the start time point of receiving data by the DS-user terminal, so as to synchronize with the user terminal and the network-side device.

In a first possible implementation manner of the eighth aspect,

the sender is specifically configured to send the first synchronization signal to the DS-user terminal on a preset uplink time-frequency resource.

With reference to the eighth aspect or the first possible implementation manner of the eighth aspect, in a second possible implementation manner, the user terminal further includes a receiver;

the sender is further configured to send a first instruction message to the DS-user terminal after the user terminal is synchronized with the network-side device and the DS-user terminal, so that the DS-user terminal changes an idle DRX period according to the first instruction message, where the first instruction message is sent by the network-side device to the user terminal, the first instruction message is used to instruct that the idle DRX period be changed, and the first instruction message includes a message type and a period value of the idle DRX period;

the receiver is configured to receive a first response message that is from the DS-user terminal and corresponding to the first instruction message sent by the sender; and

the sender is further configured to send the first response message, which is received by the receiver, to the network-side device, so that the network-side device learns, according to the first response message, success in changing the idle DRX period.

According to a ninth aspect, an embodiment of the present invention further provides a user terminal, including:

a receiver, configured to receive a synchronization signal from a DS-user terminal when communication is performed between the DS-user terminal and the user terminal in a D2D manner;

a processor, configured to acquire a first timing offset according to the synchronization signal received by the receiver from the DS-user terminal, where the first timing offset is a difference between a start time point of sending data by the DS-user terminal and a start time point of receiving data by the user terminal, and the start time point of receiving data by the user terminal is a start time point of receiving data after the user terminal is synchronized with a network-side device; and

a sender, configured to send the first timing offset, which is acquired by the processor, to the DS-user terminal, where the first timing offset is used by the DS-user terminal to adjust, according to the first timing offset, the start time point of sending data by the DS-user terminal, so as to synchronize with the user terminal and the network-side device.

In a first possible implementation manner of the ninth aspect,

the processor is specifically configured to perform calculation on the synchronization signal received by the receiver from the DS-user terminal, so as to obtain a second synchronization peak; and determine the first timing offset according to a time point corresponding to the second synchronization peak.

With reference to the ninth aspect or the first possible implementation manner of the ninth aspect, in a second possible implementation manner,

the sender is specifically configured to send the first timing offset, which is acquired by the processor, to the DS-user terminal on a preset uplink time-frequency resource.

With reference to the ninth aspect or either the first possible implementation manner or the second possible implementation manner of the ninth aspect, in a third possible implementation manner,

the sender is further configured to send a first instruction message to the DS-user terminal after the user terminal is synchronized with the network-side device and the DS-user terminal, so that the DS-user terminal changes an idle DRX period according to the first instruction message, where the first instruction message is sent by the network-side device to the user terminal, the first instruction message is used to instruct that the idle DRX period be changed, and the first instruction message includes a message type and a period value of the idle DRX period;

the receiver is further configured to receive a first response message that is from the DS-user terminal and corresponding to the first instruction message sent by the sender; and

the sender is further configured to send the first response message, which is received by the receiver, to the network-side device, so that the network-side device learns, according to the first response message, success in changing the idle DRX period.

According to the synchronization method and apparatus provided in the embodiments of the present invention, a DS-user terminal acquires a first timing offset, where the first timing offset is a difference between a start time point of receiving data by the DS-user terminal and a start time point of sending data by a DM-user terminal, or is a difference between a start time point of sending data by the DS-user terminal and a start time point of receiving data by a DM-user terminal, the start time point of sending data by the DM-user terminal is a start time point of sending data after the DM-user terminal is synchronized with a network-side device, and the start time point of receiving data by the DM-user terminal is a start time point of receiving data after the DM-user terminal is synchronized with the network-side device; and according to the first timing offset, and the DS-user terminal adjusts the start time point of receiving data by the DS-user terminal or the start time point of sending data by the DS-user terminal, so as to synchronize with the DM-user terminal and the network-side device. By means of this solution, after the DM-user terminal is synchronized with the network-side device, because the DS-user terminal can get synchronized with the network-side device by synchronizing with the DM-user terminal, synchronization without network coverage can be supported between the DS-user terminal and the network-side device.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention.

FIG. 1 is a flowchart of a synchronization method according to an embodiment of the present invention;

FIG. 2 is a flowchart of a synchronization method according to an embodiment of the present invention;

FIG. 3 is a flowchart of a synchronization method according to an embodiment of the present invention;

FIG. 4 is an interaction diagram of a synchronization method according to an embodiment of the present invention;

FIG. 5 is a schematic diagram of a time difference between a start time point of receiving data by a DS-user terminal and a start-up time point of the DS-user terminal according to an embodiment of the present invention;

FIG. 6 is a schematic diagram of an early or late start-up time point of a user terminal according to an embodiment of the present invention;

FIG. 7 is an interaction diagram of a synchronization method according to an embodiment of the present invention;

FIG. 8 is a schematic diagram of a time difference between a start-up time point of a DM-user terminal and a start time point of receiving data by the DM-user terminal according to an embodiment of the present invention;

FIG. 9 is an interaction diagram of a synchronization method according to an embodiment of the present invention;

FIG. 10 is a schematic structural diagram of a user terminal according to an embodiment of the present invention;

FIG. 11 is a schematic structural diagram of a user terminal according to an embodiment of the present invention;

FIG. 12 is a schematic structural diagram of a user terminal according to an embodiment of the present invention;

FIG. 13 is a schematic structural diagram of a user terminal according to an embodiment of the present invention;

FIG. 14 is a schematic structural diagram of a user terminal according to an embodiment of the present invention;

FIG. 15 is a schematic structural diagram of a user terminal according to an embodiment of the present invention;

FIG. 16 is a schematic structural diagram of a user terminal according to an embodiment of the present invention;

FIG. 17 is a schematic structural diagram of a user terminal according to an embodiment of the present invention;

FIG. 18 is a schematic structural diagram of a user terminal according to an embodiment of the present invention; and

FIG. 19 is a block diagram of a communications system according to an embodiment of the present invention.

### DETAILED DESCRIPTION

The following clearly describes the technical solutions in the embodiments of the present invention with reference to the accompanying drawings in the embodiments of the present invention. Apparently, the described embodiments are merely some but not all of the embodiments of the present invention.

Various technologies described in this specification may be applied to various wireless communications systems, for example, current 2G and 3G communications systems and a next-generation communications system, for example, a Global System for Mobile Communications (GSM, Global System for Mobile Communications), a Code Division Multiple Access (CDMA, Code Division Multiple Access) system, a Time Division Multiple Access (TDMA, Time Division Multiple Access) system, a Wideband Code Division Multiple Access (WCDMA, Wideband Code Division Multiple Access) system, a Frequency Division Multiple Access (FDMA, Frequency Division Multiple Access) system, an Orthogonal Frequency-Division Multiple Access (OFDMA, Orthogonal Frequency-Division Multiple Access) system, a single-carrier Frequency Division Multiple Access (SC-FDMA, Single Carrier Frequency Division Multiple Addressing) system, a general packet radio service (GPRS, General Packet Radio Service) system, a Long Term Evolution (LTE, Long Term Evolution) system, and other communications systems of this type.

A device-to-device master user terminal (D2D Master user terminal, DM-user terminal) and a DS-user terminal are two user terminals that communicate in a D2D manner, where the DM-user terminal is a user terminal in coverage of a network-side device, and the DS-user terminal is a user terminal outside the coverage of the network-side device. In a normal communication process, to reduce power consumption, the network-side device configures idle (idle) DRX (Discontinuous Reception, discontinuous reception) for the DM-user terminal and the DS-user terminal separately, and therefore, after shifting to a normal operation stage, the DM-user terminal and the DS-user terminal are in the idle DRX state in most time. That is, the DM-user terminal and the DS-user terminal wake up once at a specified interval according to a configured idle DRX period.

The following describes a wake-up period of the DM-user terminal and the DS-user terminal by using an example in which the idle DRX period configured by the network-side device for the DM-user terminal and the DS-user terminal is 10 minutes.

The DM-user terminal and the DS-user terminal each have two clock crystal oscillators, one is a first clock crystal oscillator, and the other is a second clock crystal oscillator; and the second clock crystal oscillator is relatively more stable and consumes more power (higher stability of a clock crystal oscillator indicates higher accuracy of the clock crystal oscillator). Therefore, to reduce power consumption, the second clock crystal oscillator may be generally turned off during sleep time of the DM-user terminal and the DS-user terminal, that is, only the first clock crystal oscillator works. In this way, because the first clock crystal oscillator of the DM-user terminal and the first clock crystal oscillator of the DS-user terminal are less stable, that is, the first clock crystal oscillator of the DM-user terminal and the first clock crystal oscillator of the DS-user terminal are less accurate, the wake-up period of the DM-user terminal and the wake-up period of the DS-user terminal have changed in contrast with a wake-up period configured by the network-side device. For example, the wake-up period of the DM-user terminal is 10.4 minutes, and the wake-up period of the DS-user terminal is 9.8 minutes. Consequently, after the DM-user terminal and the DS-user terminal wake up according to the wake-up period, a start time point of sending data by the DM-user terminal and a start time point of sending data by the DS-user terminal are earlier or later than a start time point of receiving data by the network-side device, or a start time point of receiving data by the DM-user terminal and a start time point of receiving data by the DS-user terminal are earlier or later than a start time point of sending data by the network-side device.

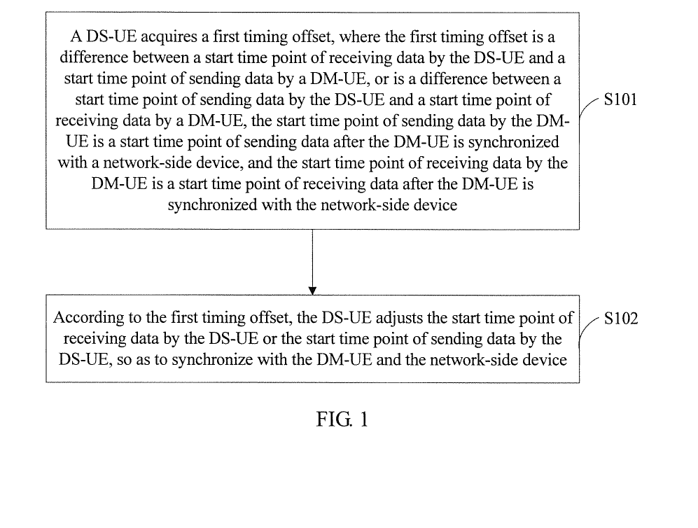

An embodiment of the present invention provides a synchronization method, and relates to a DS-user terminal side. As shown in FIG. 1, the method may include:

S101. A DS-user terminal acquires a first timing offset, where the first timing offset is a difference between a start time point of receiving data by the DS-user terminal and a start time point of sending data by a DM-user terminal, or is a difference between a start time point of sending data by the DS-user terminal and a start time point of receiving data by a DM-user terminal, the start time point of sending data by the DM-user terminal is a start time point of sending data after the DM-user terminal is synchronized with a network-side device, and the start time point of receiving data by the DM-user terminal is a start time point of receiving data after the DM-user terminal is synchronized with the network-side device.

In the embodiment of the present invention, both the DM-user terminal and the DS-user terminal are user terminals, the DM-user terminal is a user terminal in coverage of the network-side device, and the DS-user terminal is a user terminal outside the coverage of the network-side device.

Optionally, an ID (Identity, serial number) of the DM-user terminal and an ID of the DS-user terminal may be set in chips of the DM-user terminal and the DS-user terminal, respectively, and the ID of the DM-user terminal is correlated with the ID of the DS-user terminal, so that the DM-user terminal can synchronize or communicate only with the DS-user terminal correlated with the DM-user terminal; correspondingly, the DS-user terminal can synchronize or communicate only with the DM-user terminal correlated with the DS-user terminal.

The network-side device provided in the embodiment of the present invention may include a device such as a base station. The DM-user terminal and the DS-user terminal may include a terminal such as a smart meter.

For example, due to a difference of an internal clock crystal oscillator between the DM-user terminal and the DS-user terminal, after the DM-user terminal and the DS-user terminal wake up according to an idle DRX period configured by the network-side device, the start time point of sending data by the DM-user terminal and the start time point of sending data by the DS-user terminal may be earlier or later than a start time point of receiving data by the network-side device, or the start time point of receiving data by the DM-user terminal and the start time point of receiving data by the DS-user terminal may be earlier or later than a start time point of sending data by the network-side device. If the DM-user terminal and the DS-user terminal need to communicate with the network-side device, the DM-user terminal and the DS-user terminal need to synchronize with the network-side device first. After the DM-user terminal is synchronized with the network-side device, the DS-user terminal needs to adjust, according to a timing offset between the DS-user terminal and the network-side device when communication is performed between the DS-user terminal and the DM-user terminal in a D2D manner, the start time point of sending data by the DS-user terminal and the start time point of receiving data by the DS-user terminal. The DS-user terminal is a user terminal outside coverage of the network-side device, and therefore, an embodiment of the present invention provides a synchronization method, in which the DS-user terminal implements synchronization with the network-side device by synchronizing with the DM-user terminal that has been synchronized with the network-side device.

Specifically, the DS-user terminal acquires the first timing offset, where the first timing offset is a difference between the start time point of receiving data by the DS-user terminal and the start time point of sending data by the DM-user terminal, or is a difference between the start time point of sending data by the DS-user terminal and the start time point of receiving data by a DM-user terminal, the start time point of sending data by the DM-user terminal is a start time point of sending data after the DM-user terminal is synchronized with the network-side device, and the start time point of receiving data by the DM-user terminal is a start time point of receiving data after the DM-user terminal is synchronized with the network-side device.

It should be noted that because the DM-user terminal is in the coverage of the network-side device, the DM-user terminal may be synchronized with the network-side device by using an existing synchronization technology, which may specifically include:

(1) The DM-user terminal needs to be synchronized with the network-side device after waking up according to the configured idle DRX period.

(2) The DM-user terminal searches for a synchronization signal that is sent by the network-side device and used to synchronize the start time point of sending data by the network-side device with the start time point of receiving data by the DM-user terminal; according to the synchronization signal used to synchronize the start time point of sending data by the network-side device with the start time point of receiving data by the DM-user terminal, acquires a timing offset between the network-side device and the DM-user terminal; and according to the timing offset between the network-side device and the DM-user terminal, adjusts the start time point of receiving data by the DM-user terminal, so as to synchronize with the network-side device.

Specifically, the DM-user terminal may acquire a peak of the synchronization signal according to the synchronization signal that is sent by the network-side device and used to synchronize the start time point of sending data by the network-side device with the start time point of receiving data by the DM-user terminal, and according to the peak of the synchronization signal, obtain the timing offset between the network-side device and the DM-user terminal Therefore, according to the timing offset between the network-side device and the DM-user terminal, the DM-user terminal adjusts the start time point of receiving data by the DM-user terminal, so as to complete downlink synchronization with the network-side device.

A process of uplink synchronization between the DM-user terminal and the network-side device is similar to a process of downlink synchronization between the DM-user terminal and the network-side device, and will be described in detail in a subsequent embodiment.

S102. According to the first timing offset, the DS-user terminal adjusts the start time point of receiving data by the DS-user terminal or the start time point of sending data by the DS-user terminal, so as to synchronize with the DM-user terminal and the network-side device.

After the DS-user terminal acquires the first timing offset, the DS-user terminal may adjust, according to the first timing offset, the start time point of receiving data by the DS-user terminal or the start time point of sending data by the DS-user terminal, so as to synchronize with the DM-user terminal and the network-side device. Before the DS-user terminal acquires the first timing offset, the DM-user terminal has completed synchronization with the network-side device, and therefore, after the DS-user terminal adjusts, according to the first timing offset, the start time point of receiving data by the DS-user terminal or the start time point of sending data by the DS-user terminal, the DS-user terminal completes synchronization with the DM-user terminal, so that the DS-user terminal completes synchronization with the network-side device.

Specifically, if the first timing offset acquired by the DS-user terminal is a difference between the start time point of sending data by the DM-user terminal and the start time point of receiving data by the DS-user terminal, the DS-user terminal may adjust, according to the first timing offset, the start time point of receiving data by the DS-user terminal, that is, downlink synchronization is completed between the DS-user terminal and the DM-user terminal; correspondingly, if the first timing offset acquired by the DS-user terminal is a difference between the start time point of sending data by the DS-user terminal and the start time point of receiving data by the DM-user terminal, the DS-user terminal may adjust, according to the first timing offset, the start time point of sending data by the DS-user terminal, that is, uplink synchronization is completed between the DS-user terminal and the DM-user terminal. A specific process of completing downlink synchronization or uplink synchronization by the DS-user terminal will be described in detail in a subsequent embodiment.

It should be noted that because the DM-user terminal is generally close to the DS-user terminal, a delay of transmitting data between the DM-user terminal and the DS-user terminal is ignorable. That is, when downlink synchronization is completed between the DS-user terminal and the DM-user terminal, it may be deemed that uplink synchronization is also completed between the DS-user terminal and the DM-user terminal; correspondingly, when uplink synchronization is completed between the DS-user terminal and the DM-user terminal, it may be deemed that downlink synchronization is also completed between the DS-user terminal and the DM-user terminal.

By now, synchronization has been completed between the DS-user terminal, the DM-user terminal, and the network-side device.

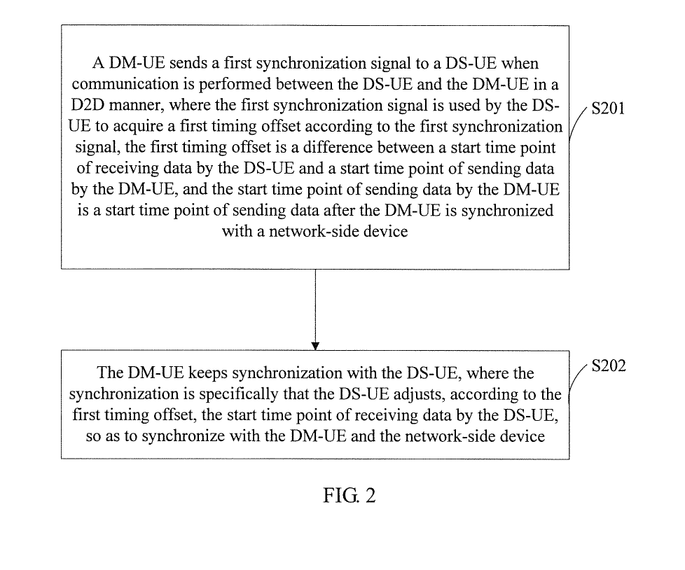

An embodiment of the present invention further provides a synchronization method, and relates to a DM-user terminal side. As shown in FIG. 2, the method may include:

S201. A DM-user terminal sends a first synchronization signal to a DS-user terminal when communication is performed between the DS-user terminal and the DM-user terminal in a D2D manner, where the first synchronization signal is used by the DS-user terminal to acquire a first timing offset according to the first synchronization signal, the first timing offset is a difference between a start time point of receiving data by the DS-user terminal and a start time point of sending data by the DM-user terminal, and the start time point of sending data by the DM-user terminal is a start time point of sending data after the DM-user terminal is synchronized with a network-side device.

Due to a difference of an internal clock crystal oscillator between the DM-user terminal and the DS-user terminal, after the DM-user terminal and the DS-user terminal wake up according to an idle DRX period configured by the network-side device, the start time point of sending data by the DM-user terminal and the start time point of sending data by the DS-user terminal may be earlier or later than a start time point of receiving data by the network-side device, or the start time point of receiving data by the DM-user terminal and the start time point of receiving data by the DS-user terminal may be earlier or later than a start time point of sending data by the network-side device. If the DM-user terminal and the DS-user terminal need to communicate with the network-side device, the DM-user terminal and the DS-user terminal need to synchronize with the network-side device first. After the DM-user terminal is synchronized with the network-side device, the DM-user terminal sends the first synchronization signal to the DS-user terminal when communication is performed between the DS-user terminal and the DM-user terminal in the D2D manner, where the first synchronization signal may be used by the DS-user terminal to acquire the first timing offset according to the first synchronization signal, the first timing offset is a difference between the start time point of receiving data by the DS-user terminal and the start time point of sending data by the DM-user terminal, and the start time point of sending data by the DM-user terminal is the start time point of sending data after the DM-user terminal is synchronized with the network-side device.

S202. The DM-user terminal keeps synchronization with the DS-user terminal, where the synchronization is specifically that the DS-user terminal adjusts, according to the first timing offset, the start time point of receiving data by the DS-user terminal, so as to synchronize with the DM-user terminal and the network-side device.

After the DM-user terminal sends the first synchronization signal to the DS-user terminal, the DS-user terminal may acquire the first timing offset according to the first synchronization signal, and adjust, according to the first timing offset, the start time point of receiving data by the DS-user terminal, so as to synchronize with the DM-user terminal and the network-side device.

Optionally, the first synchronization signal may be generated by the DM-user terminal according to a last bit or another specified bit of an ID of the DM-user terminal, which is not limited in the present invention. For example, the ID of the DM-user terminal has 8 bits in total, which are A0A1A2A3A4A5A6A7. The A7 bit may be selected to generate the first synchronization signal, or the A5 bit may be selected to generate the first synchronization signal.

In the embodiment of the present invention, before the DS-user terminal completes synchronization with the DM-user terminal, the DM-user terminal has completed synchronization with the network-side device. Therefore, after the DS-user terminal completes synchronization with the DM-user terminal, the DS-user terminal also completes synchronization with the network-side device.

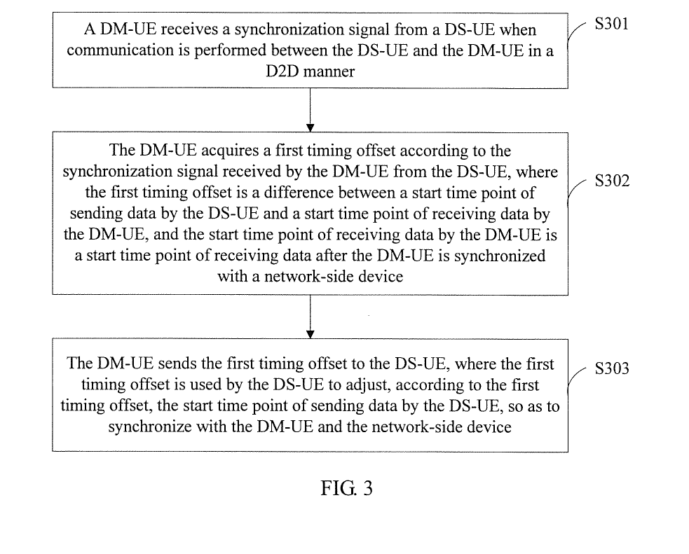

An embodiment of the present invention further provides a synchronization method, and relates to a DM-user terminal side. As shown in FIG. 3, the method may include:

S301. A DM-user terminal receives a synchronization signal from a DS-user terminal when communication is performed between the DS-user terminal and the DM-user terminal in a D2D manner.

Due to a difference of an internal clock crystal oscillator between the DM-user terminal and the DS-user terminal, after the DM-user terminal and the DS-user terminal wake up according to an idle DRX period configured by a network-side device, a start time point of sending data by the DM-user terminal and a start time point of sending data by the DS-user terminal may be earlier or later than a start time point of receiving data by the network-side device, or a start time point of receiving data by the DM-user terminal and a start time point of receiving data by the DS-user terminal may be earlier or later than a start time point of sending data by the network-side device. If the DM-user terminal and the DS-user terminal need to communicate with the network-side device, the DM-user terminal and the DS-user terminal need to synchronize with the network-side device first. After the DM-user terminal is synchronized with the network-side device, when communication is performed between the DS-user terminal and the DM-user terminal in the D2D manner, the DM-user terminal receives a synchronization signal from the DS-user terminal. At this time, the DS-user terminal has not synchronized with the network-side device yet.

Optionally, the synchronization signal received by the DM-user terminal from the DS-user terminal may be generated by the DS-user terminal according to a last bit or another specified bit of an ID of the DS-user terminal, which is not limited in the present invention. For example, the ID of the DS-user terminal has 8 bits in total, which are B0B1B2B3B4B5B6B7. The B7 bit may be selected to generate the synchronization signal received by the DM-user terminal from the DS-user terminal, or the B5 bit may be selected to generate the synchronization signal received by the DM-user terminal from the DS-user terminal.

S302. The DM-user terminal acquires a first timing offset according to the synchronization signal received by the DM-user terminal from the DS-user terminal, where the first timing offset is a difference between a start time point of sending data by the DS-user terminal and a start time point of receiving data by the DM-user terminal, and the start time point of receiving data by the DM-user terminal is a start time point of receiving data after the DM-user terminal is synchronized with a network-side device.

After the DM-user terminal receives the synchronization signal sent by the DS-user terminal, the DM-user terminal may acquire the first timing offset according to the synchronization signal received by the DM-user terminal from the DS-user terminal, where the first timing offset is a difference between the start time point of sending data by the DS-user terminal and the start time point of receiving data by the DM-user terminal, and the start time point of receiving data by the DM-user terminal is the start time point of receiving data after the DM-user terminal is synchronized with the network-side device.

S303. The DM-user terminal sends the first timing offset to the DS-user terminal, where the first timing offset is used by the DS-user terminal to adjust, according to the first timing offset, the start time point of sending data by the DS-user terminal, so as to synchronize with the DM-user terminal and the network-side device.

After the DM-user terminal acquires the first timing offset, the DM-user terminal may send the first timing offset to the DS-user terminal, where the first timing offset may be used by the DS-user terminal to adjust, according to the first timing offset, the start time point of sending data by the DS-user terminal, so as to complete synchronization with the DM-user terminal and the network-side device.

In the embodiment of the present invention, before the DS-user terminal completes synchronization with the DM-user terminal, the DM-user terminal has completed synchronization with the network-side device. Therefore, after the DS-user terminal completes synchronization with the DM-user terminal, the DS-user terminal also completes synchronization with the network-side device.

According to the synchronization method provided in the embodiment of the present invention, a DS-user terminal acquires a first timing offset, where the first timing offset is a difference between a start time point of receiving data by the DS-user terminal and a start time point of sending data by a DM-user terminal, or is a difference between a start time point of sending data by the DS-user terminal and a start time point of receiving data by a DM-user terminal, the start time point of sending data by the DM-user terminal is a start time point of sending data after the DM-user terminal is synchronized with a network-side device, and the start time point of receiving data by the DM-user terminal is a start time point of receiving data after the DM-user terminal is synchronized with the network-side device; and the DS-user terminal adjusts, according to the first timing offset, the start time point of receiving data by the DS-user terminal or the start time point of sending data by the DS-user terminal, so as to synchronize with the DM-user terminal and the network-side device. By means of this solution, after the DM-user terminal is synchronized with the network-side device, because the DS-user terminal can get synchronized with the network-side device by synchronizing with the DM-user terminal, synchronization without network coverage can be supported between the DS-user terminal and the network-side device.

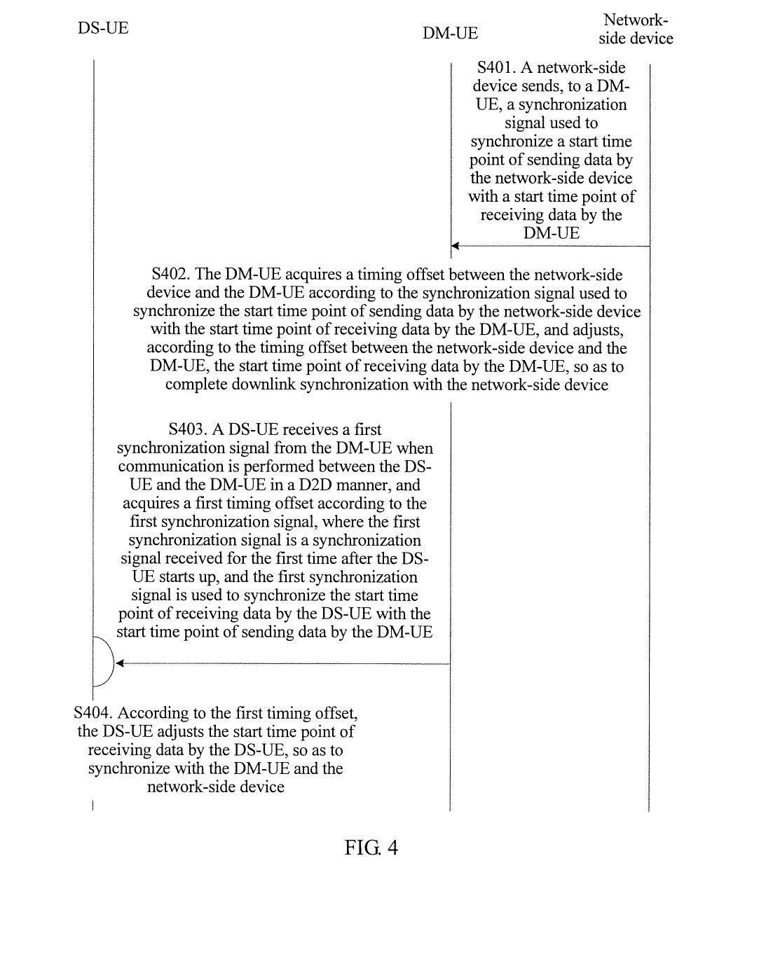

An embodiment of the present invention further provides a synchronization method. As shown in FIG. 4, the method may include:

S401. A network-side device sends, to a DM-user terminal, a synchronization signal used to synchronize a start time point of sending data by the network-side device with a start time point of receiving data by the DM-user terminal.

In the embodiment of the present invention, both the DM-user terminal and the DS-user terminal are user terminals, the DM-user terminal is a user terminal in coverage of the network-side device, and the DS-user terminal is a user terminal outside the coverage of the network-side device.

Optionally, an ID of the DM-user terminal and an ID of the DS-user terminal may be set in chips of the DM-user terminal and the DS-user terminal, respectively, and the ID of the DM-user terminal is correlated with the ID of the DS-user terminal, so that the DM-user terminal can synchronize or communicate only with the DS-user terminal correlated with the DM-user terminal; correspondingly, the DS-user terminal can synchronize or communicate only with the DM-user terminal correlated with the DS-user terminal.

The network-side device provided in the embodiment of the present invention may include a device such as a base station. The DM-user terminal and the DS-user ten final may include a terminal such as a smart meter.

In a normal communication process, after the DM-user terminal wakes up according to an idle DRX period configured for the DM-user terminal by the network-side device, if the DM-user terminal needs to communicate with the network-side device, the DM-user terminal first searches for a synchronization signal that is sent by the network-side device and used to synchronize the start time point of sending data by the network-side device with a start time point of receiving data by the DM-user terminal; and performs synchronization with the network-side device according to the synchronization signal.

It should be noted that: when the network-side device communicates with the DM-user terminal, the DM-user terminal first acquires a difference according to the synchronization signal, where the difference is a difference between the start time point of receiving data by the DM-user terminal and the start time point of sending data by the network-side device, namely, a timing offset between the DM-user terminal and the network-side device, and the synchronization signal is sent by the network-side device and used to synchronize the start time point of sending data by the network-side device with the start time point of receiving data by the DM-user terminal; therefore, according to the timing offset, the DM-user terminal adjusts the start time point of receiving data by the DM-user terminal, so as to synchronize with the start time point of sending data by the network-side device.

Further, a delay of transmitting data between the network-side device and the DM-user terminal is already counted when the DM-user terminal adjusts the start time point of receiving data by the DM-user terminal.

Optionally, the idle DRX period may be configured for the user terminal by the network-side device, or may be set by a manufacturer before delivery of the user terminal, where the user terminal may include the DM-user terminal and the DS-user terminal.

S402. The DM-user terminal acquires a timing offset between the network-side device and the DM-user terminal according to the synchronization signal used to synchronize the start time point of sending data by the network-side device with the start time point of receiving data by the DM-user terminal, and adjusts, according to the timing offset between the network-side device and the DM-user terminal, the start time point of receiving data by the DM-user terminal, so as to complete downlink synchronization with the network-side device.

After the DM-user terminal receives the synchronization signal that is from the network-side device and used to synchronize the start time point of sending data by the network-side device with the start time point of receiving data by the DM-user terminal, the DM-user terminal may acquire a peak of the synchronization signal according to the synchronization signal, and obtain the timing offset between the network-side device and the DM-user terminal according to the peak of the synchronization signal. Therefore, according to the timing offset between the network-side device and the DM-user terminal, the DM-user terminal adjusts the start time point of receiving data by the DM-user terminal, so as to perform downlink synchronization with the network-side device.

A process of uplink synchronization between the DM-user terminal and the network-side device is similar to a process of downlink synchronization between the DM-user terminal and the network-side device, and may specifically include the following:

The DM-user terminal sends an access signal to the network-side device; after the network-side device receives the access signal, the network-side device obtains, by means of calculation according to the access signal, a difference between the start time point of receiving data by the network-side device and timing of an internal clock crystal oscillator of the network-side device, and sends the difference to the DM-user terminal, so that the DM-user terminal can adjust, according to the difference, the start time point of sending data by the DM-user terminal, to synchronize with the start time point of receiving data by the network-side device, thereby completing uplink synchronization between the DM-user terminal and the network-side device. For example, the network-side device determines, by means of calculation and according to the access signal sent by the DM-user terminal, that the difference between the start time point of sending data by the DM-user terminal and the start time point of receiving data by the network-side device is 5 milliseconds. After the network-side device sends the time difference of 5 milliseconds to the DM-user terminal, when sending data to the network-side device, the DM-user terminal may adjust the start time point of sending data by the DM-user terminal 5 milliseconds earlier, that is, the DM-user terminal sends the data to the network-side device 5 milliseconds earlier.

It should be noted that because the DM-user terminal is in the coverage of the network-side device, the DM-user terminal may be synchronized with the network-side device by using an existing synchronization technology, which is not repeated herein.

S403. A DS-user terminal receives a first synchronization signal from the DM-user terminal when communication is performed between the DS-user terminal and the DM-user terminal in a D2D manner, and acquires a first timing offset according to the first synchronization signal, where the first synchronization signal is a synchronization signal received for the first time after the DS-user terminal starts up, where the first synchronization signal is used to synchronize the start time point of receiving data by the DS-user terminal with the start time point of sending data by the DM-user terminal.

Optionally, the first synchronization signal may be generated by the DM-user terminal according to a last bit or another specified bit of an ID of the DM-user terminal, which is not limited in the present invention. For example, the ID of the DM-user terminal has 8 bits in total, which are A0A1A2A3A4A5A6A7. The A7 bit may be selected to generate the first synchronization signal, or the A5 bit may be selected to generate the first synchronization signal.

Specifically, a method used by the DS-user terminal to acquire the first timing offset according to the first synchronization signal may include:

a. The DS-user terminal performs calculation on the first synchronization signal to obtain a first synchronization peak.

For example, the calculation is specifically as follows: Assuming that the first synchronization signal received by the DS-user terminal is (A0+j*B0), (A1+j*B1), (A2+j*B2), and (A3+j*B3), locally stored synchronization sequences (C0−j*D0), (C1−j*D1), and (C2−j*D2) are used to perform calculation on the first synchronization signal. Specifically, after the calculation on the first synchronization signal is performed, the sequences are:

X0=(A0+j*B0)*(C0−j*D0)+(A1+j*B1)*(C1−j*D1)+(A2+j*B2)*(C2−j*D2); and

X1=(A1+j*B1)*(C0−j*D0)+(A2+j*B2)*(C1−j*D1)+(A3+j*B3)*(C2−j*D2).

A value with a greater amplitude in the X0 sequence and the X1 sequence is used as a first synchronization peak.

b. The DS-user terminal determines the first timing offset according to a time point corresponding to the first synchronization peak.

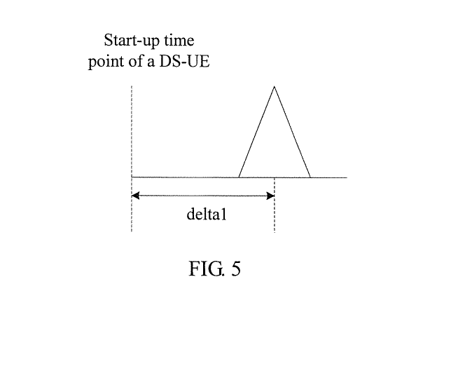

As shown in FIG. 5, FIG. 5 is a schematic diagram of calculating a difference delta1 between the start time point of receiving data by the DS-user terminal and a start-up time point of the DS-user terminal. It can be seen that the difference between the start time point of receiving data by the DS-user terminal and the start-up time point of the DS-user terminal may be a time difference between the start time point of sending data by the DM-user terminal and the start time point of receiving data by the DS-user terminal. The start time point of receiving data by the DS-user terminal may be represented by the time point corresponding to the first synchronization peak obtained by performing calculation on the first synchronization signal after the DS-user terminal receives the first synchronization signal.

A person of ordinary skill in the art may understand that in a communication process, data is transmitted by using a frame as a unit. Using a 10-millisecond frame as an example, if each frame includes 10 subframes, which may be subframe 0, subframe 1, subframe 2, . . . , and subframe 9, each subframe is 1 millisecond.

Optionally, because a clock crystal oscillator error of the DS-user terminal may cause the start-up time point of the DS-user terminal to be earlier or later than the time point of the network-side device, the DM-user terminal may send the first synchronization signal to the DS-user terminal for at least two times in order to reduce power consumption and complete synchronization between the DS-user terminal and the DM-user terminal and the network-side device more accurately and better.

It should be noted that because the clock crystal oscillator error of the DS-user terminal may cause the start-up time point of the DS-user terminal to be earlier or later than the time point of the network-side device, and the first synchronization signal is sent by the DM-user terminal to the DS-user terminal, the DM-user terminal may send the first synchronization signal to the DS-user terminal for at least two times. This is because if the DM-user terminal sends the first synchronization signal only once and the time point of sending the first synchronization signal by the DM-user terminal is earlier than the start-up time point of the DS-user terminal, the DS-user terminal is unable to receive the first synchronization signal.

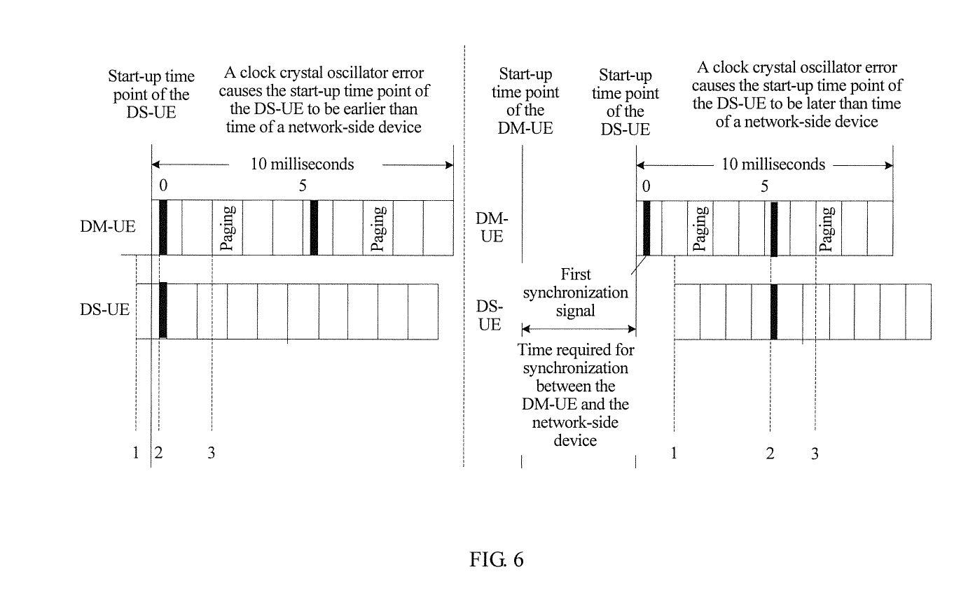

For example, as shown in FIG. 6, FIG. 6 is a schematic diagram in which the clock crystal oscillator error causes the start-up time point of the DS-user terminal to be earlier than the time point of the network-side device and causes the start-up time point of the DS-user terminal to be later than the time point of the network-side device, separately, where the start-up time point of the DS-user terminal is the start-up time point of the DS-user terminal that is set by the network-side device according to the time point of the network-side device, and the start-up time point of the DM-user terminal is the start-up time point of the DM-user terminal that is set by the network-side device according to the time point of the network-side device; 1 is an actual start-up time point of the DS-user terminal; 2 is a time point of synchronization between the DS-user terminal and the DM-user terminal; and 3 is a time point of receiving paging by the DS-user terminal. If the clock crystal oscillator error causes the start-up time point of the DS-user terminal to be earlier than the time point of the network-side device, the DS-user terminal may receive, after start-up, the first synchronization signal sent by the DM-user terminal in the subframe 0; if the clock crystal oscillator error causes the start-up time point of the DS-user terminal to be later than the time point of the network-side device, the DS-user terminal may receive, after start-up, the first synchronization signal sent by the DM-user terminal in the subframe 5.

Optionally, the DM-user terminal may send the first synchronization signal to the DS-user terminal in the subframe 0 and the subframe 5 separately, or may send the first synchronization signal to the DS-user terminal in the subframe 1 and the subframe 6 separately, or may send the first synchronization signal to the DS-user terminal in another subframe that meets design requirements, which is not limited in the present invention.

For example, assuming that the DM-user terminal sends the first synchronization signal to the DS-user terminal in the subframe 0 and the subframe 5 separately, if the first synchronization signal received for the first time after start-up of the DS-user terminal is the first synchronization signal in the subframe 0, an offset between the start-up time point of the DS-user terminal and the time point corresponding to the first synchronization peak obtained by the DS-user terminal is delta2=0 millisecond; if the first synchronization signal received for the first time after start-up of the DS-user terminal is the first synchronization signal in the subframe 5, an offset between the start-up time point of the DS-user terminal and the time point corresponding to the first synchronization peak obtained by the DS-user terminal is delta2=5 milliseconds.

Further, the DS-user terminal adds delta1 and delta2 obtained above to determine the first timing offset delta.

It should be noted that: because the DM-user terminal sends the first synchronization signal in the subframe 0 and the subframe 5 of each frame separately, if the DS-user terminal receives, in the subframe 0, the first synchronization signal sent by the DM-user terminal, the first synchronization signal includes subframe information of the subframe 0; correspondingly, if the DS-user terminal receives, in the subframe 5, the first synchronization signal sent by the DM-user terminal, the first synchronization signal includes subframe information of the subframe 5.

Optionally, the DS-user terminal may receive the first synchronization signal from the DM-user terminal on a preset uplink time-frequency resource. That is, on the uplink time-frequency resource of the DM-user terminal, a dedicated time domain resource and a dedicated frequency domain resource may be allocated to the DM-user terminal and the DS-user terminal, so as to send and receive the first synchronization signal.

S404. According to the first timing offset, the DS-user terminal adjusts the start time point of receiving data by the DS-user terminal, so as to synchronize with the DM-user terminal and the network-side device.

After the DS-user terminal acquires the first timing offset, the DS-user terminal may adjust, according to the first timing offset, the start time point of receiving data by the DS-user terminal to be the same as the start time point of sending data by the DM-user terminal, so as to complete downlink synchronization with the DM-user terminal. Because downlink synchronization between the DM-user terminal and the network-side device has already been completed, that is, the start time point of receiving data by the DM-user terminal is synchronized with the start time point of sending data by the network-side device, the DS-user terminal also completes downlink synchronization with the network-side device when the DS-user terminal completes downlink synchronization with the DM-user terminal.

It should be noted that because the DM-user terminal is generally close to the DS-user terminal, a delay of transmitting data between the DM-user terminal and the DS-user terminal is ignorable. That is, when the DS-user terminal completes downlink synchronization with the DM-user terminal, it may be deemed that the DS-user terminal also completes uplink synchronization with the DM-user terminal.

For example, assuming that the first timing offset acquired by the DS-user terminal is 5 milliseconds, namely, the DS-user terminal learns that the difference between the start time point of receiving data by the DS-user terminal and the start time point of sending data by the DM-user terminal is 5 milliseconds, the DS-user terminal may adjust, according to the difference, the start time point of receiving data by the DS-user terminal 5 milliseconds earlier, so that the DS-user terminal completes synchronization with the DM-user terminal.

Optionally, due to an error caused by a first clock crystal oscillator, when the DS-user terminal is in each wake-up period, an unfixed offset exists between the start time point of receiving data by the DS-user terminal and the start time point of sending data by the DM-user terminal synchronized with the network-side device. Therefore, according to the acquired first timing offset, the DS-user terminal may adjust the start time point of receiving data by the DS-user terminal, so as to complete synchronization with the DM-user terminal and the network-side device.

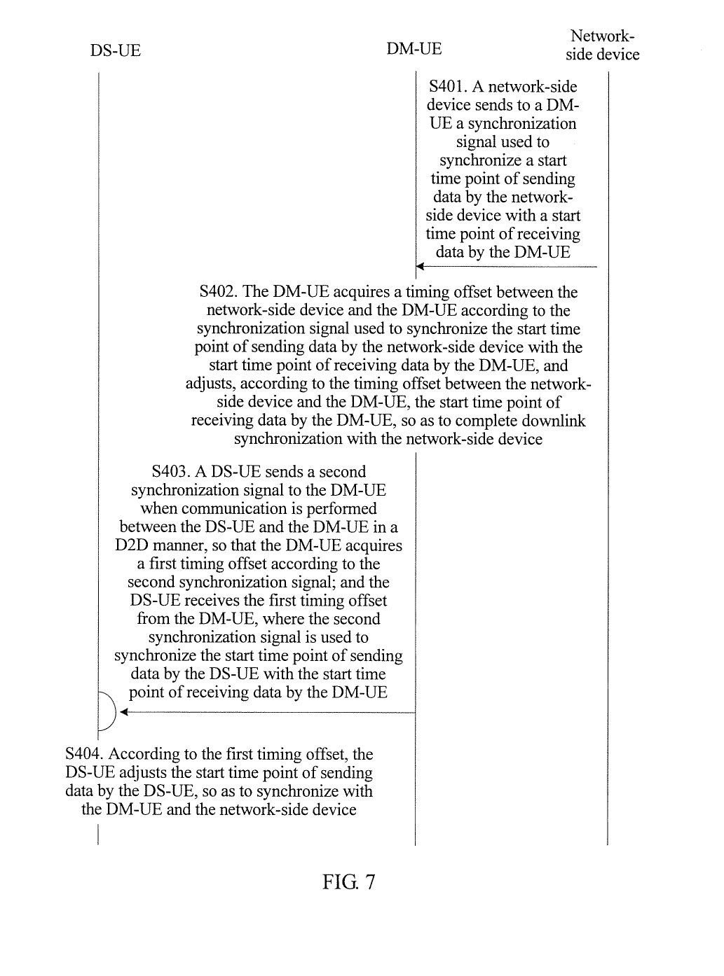

An embodiment of the present invention further provides a synchronization method. As shown in FIG. 7, the synchronization method provided in this embodiment differs from the synchronization method provided in the foregoing embodiment in S403 and S404.

Specifically, in the synchronization method provided in this embodiment, S403 and S404 may be:

S403. The DS-user terminal sends a second synchronization signal to the DM-user terminal when communication is performed between the DS-user terminal and the DM-user terminal in a D2D manner, so that the DM-user terminal acquires a first timing offset according to the second synchronization signal; and the DS-user terminal receives the first timing offset from the DM-user terminal, where the second synchronization signal is used to synchronize the start time point of sending data by the DS-user terminal with the start time point of receiving data by the DM-user terminal.

Optionally, the second synchronization signal may be generated by the DS-user terminal according to a last bit or another specified bit of an ID of the DS-user terminal, which is not limited in the present invention. For example, the ID of the DS-user terminal has 8 bits in total, which are B0B1B2B3B4B5B6B7. The B7 bit may be selected to generate the second synchronization signal, or the B5 bit may be selected to generate the second synchronization signal.

Because a clock crystal oscillator error of the DS-user terminal may cause the start-up time point of the DS-user terminal to be earlier or later than the time point of the network-side device, the DS-user terminal may send the second synchronization signal to the DM-user terminal at least once in order to reduce power consumption and complete synchronization between the DS-user terminal and the DM-user terminal and the network-side device more accurately and better.

It should be noted that because the clock crystal oscillator error of the DS-user terminal may cause the start-up time point of the DS-user terminal to be earlier or later than the time point of the network-side device, and the second synchronization signal is sent by the DS-user terminal to the DM-user terminal, the DS-user terminal may send the second synchronization signal to the DM-user terminal at least once. That is because no matter whether the start-up time point of the DS-user terminal is early or late, the DM-user terminal can receive the second synchronization signal sent by the DS-user terminal after start-up.

After the DM-user terminal receives the second synchronization signal sent by the DS-user terminal, the DM-user terminal may perform calculation on the second synchronization signal to obtain a second synchronization peak, determine a first timing offset according to a time point corresponding to the second synchronization peak, and send the first timing offset to the DS-user terminal, so that the DS-user terminal acquires the first timing offset. Specifically, a method for calculating the second synchronization peak is the same as the method for calculating the first synchronization peak in S403 in the foregoing embodiment, and is not repeated herein.

Optionally, the DS-user terminal may receive the first timing offset from the DM-user terminal on a preset uplink time-frequency resource. That is, on the uplink time-frequency resource of the DM-user terminal, a dedicated time domain resource and a dedicated frequency domain resource may be allocated to the DM-user terminal and the DS-user terminal for sending and receiving the first timing offset.

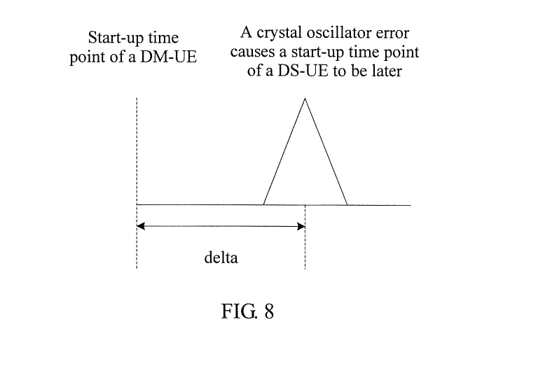

FIG. 8 is a schematic diagram of calculating a first timing offset delta. It can be seen that the first timing offset is a time difference between the start-up time point of the DM-user terminal and the start time point of receiving data by the DM-user terminal, where the time difference may be a time difference between the start time point of sending data by the DS-user terminal and the start time point of receiving data by the DM-user terminal.

Understandably, if a start position of a locally stored synchronization sequence is set to a frame header position of each frame of data, the start time point of receiving data by the DM-user terminal may be represented by the time point corresponding to the second synchronization peak obtained by performing calculation on the second synchronization signal after the DM-user terminal receives the second synchronization signal. If the start position of the locally stored synchronization sequence is set to a position in frame middle positions of each frame of data, after the DM-user terminal receives the second synchronization signal and obtains the time point corresponding to the second synchronization peak by performing calculation on the second synchronization signal, the DM-user terminal may obtain, by means calculation and according to the time point corresponding to the second synchronization peak, the start time point of receiving data by the DM-user terminal. For example, the start position of the synchronization sequence is set to the subframe 5 of each frame of data, and therefore, the time point corresponding to the second synchronization peak obtained by the DM-user terminal is the subframe 5. That is, the DM-user terminal may subtract a data length of first 4 subframes from the subframe 5, so as to obtain the start time point of receiving data by the DM-user terminal.

Specially, after receiving the first timing offset sent by the DM-user terminal, the DS-user terminal can learn that the DM-user terminal has been synchronized with the network-side device at this time.

S404. According to the first timing offset, the DS-user terminal adjusts the start time point of sending data by the DS-user terminal, so as to synchronize with the DM-user terminal and the network-side device.

After the DS-user terminal acquires the first timing offset, the DS-user terminal may adjust, according to the first timing offset, the start time point of sending data by the DS-user terminal to be the same as the start time point of receiving data by the DM-user terminal, so as to complete uplink synchronization with the DM-user terminal. Because uplink synchronization is already completed between the DM-user terminal and the network-side device, namely, the start time point of sending data by the DM-user terminal is synchronized with the start time point of receiving data by the network-side device, the DS-user terminal also completes uplink synchronization with the network-side device when the DS-user terminal completes uplink synchronization with the DM-user terminal.

It should be noted that because the DM-user terminal is generally close to the DS-user terminal, a delay of transmitting data between the DM-user terminal and the DS-user terminal is ignorable. That is, when the DS-user terminal completes uplink synchronization with the DM-user terminal, it may be deemed that the DS-user terminal also completes downlink synchronization with the DM-user terminal.

For example, assuming that the first timing offset acquired by the DS-user terminal is 5 milliseconds, namely, the DS-user terminal learns that the difference between the start time point of sending data by the DS-user terminal and the start time point of receiving data by the DM-user terminal is 5 milliseconds, the DS-user terminal may adjust, according to the difference, the start time point of sending data by the DS-user terminal 5 milliseconds earlier, so that the DS-user terminal completes synchronization with the DM-user terminal.

Optionally, due to an error caused by a first clock crystal oscillator, when the DS-user terminal is in each wake-up period, an unfixed offset exists between the start time point of sending data by the DS-user terminal and the start time point of receiving data by the DM-user terminal synchronized with the network-side device. Therefore, according to the acquired first timing offset, the DS-user terminal may adjust the start time point of sending data by the DS-user terminal, so as to complete synchronization with the DM-user terminal and the network-side device.

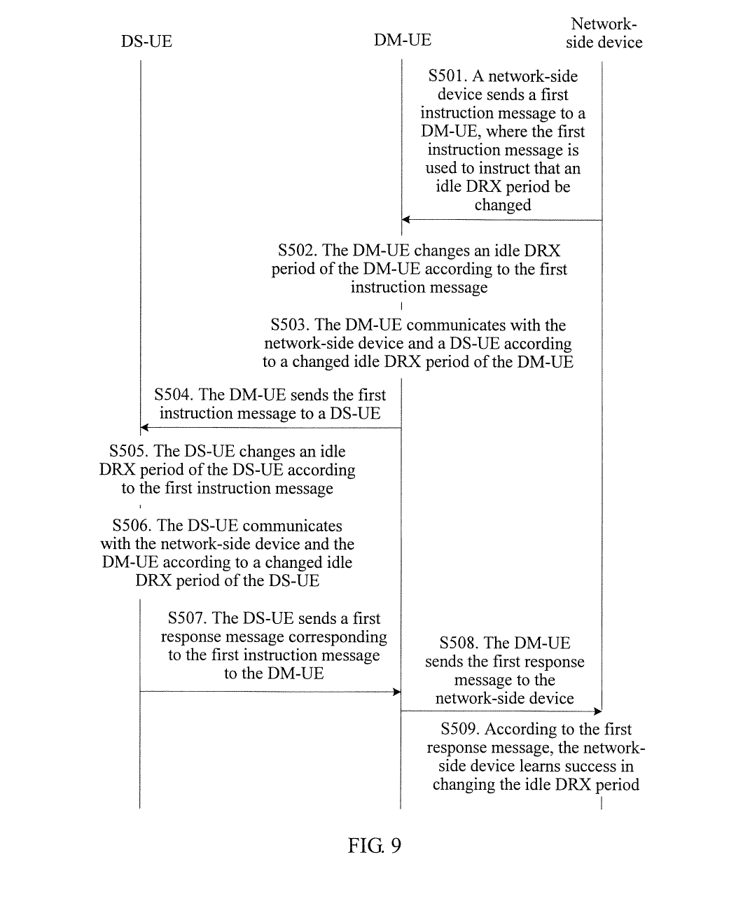

Further, after the DS-user terminal is synchronized with the DM-user terminal and the network-side device, the present invention further provides an embodiment. As shown in FIG. 9, this embodiment may include:

S501. A network-side device sends a first instruction message to a DM-user terminal, where the first instruction message is used to instruct that an idle DRX period be changed.

After the DM-user terminal is synchronized with the network-side device, if the network-side device needs to change the idle DRX period, the network-side device sends the first instruction message to the DM-user terminal, where the first instruction message may be used to instruct that the idle DRX period be changed.

Optionally, the first instruction message may include a message type and a period value of the idle DRX period. For example, the message type may be “idle DRX period change of dual user terminals”, and the period value of the idle DRX period may be any value that meets design requirements, such as 10 seconds, 60 seconds, and 600 seconds.

It should be noted that the present invention only gives an exemplary description by using an example in which the first instruction message is used to instruct that the idle DRX period be changed. The first instruction message may include but not be limited to a message for instructing that the idle DRX period be changed. That is, the first instruction message may be any data or message that meets requirements and is delivered by a network side, on which the present invention imposes no limitation.

S502. The DM-user terminal changes an idle DRX period of the DM-user terminal according to the first instruction message.

After the DM-user terminal receives the first instruction message, the DM-user terminal may change the idle DRX period of the DM-user terminal according to the first instruction message.

S503. The DM-user terminal communicates with the network-side device and a DS-user terminal according to a changed idle DRX period of the DM-user terminal.

In a subsequent communication process after the DM-user terminal changes the idle DRX period of the DM-user terminal according to the first instruction message sent by the network-side device, the DM-user terminal communicates with the network-side device and the DS-user terminal according to the changed idle DRX period of the DM-user terminal.

S504. The DM-user terminal sends the first instruction message to the DS-user terminal.

After the DS-user terminal completes synchronization with the DM-user terminal, if the DM-user terminal receives the first instruction message sent by the network-side device, the DM-user terminal sends the first instruction message to the DS-user terminal, so that the DS-user terminal may also change an idle DRX period of the DS-user terminal according to the first instruction message.

It should be noted that the present invention does not limit implementation order of S502-S503 and S504. That is, in the present invention, S502-S503 may be performed before S504; or S504 may be performed before S502-S503; or S502-S503 and S504 may be performed simultaneously.

S505. The DS-user terminal changes an idle DRX period of the DS-user terminal according to the first instruction message.

After the DS-user terminal receives the first instruction message sent by the DM-user terminal, the DS-user terminal may change the idle DRX period of the DS-user terminal according to the first instruction message.

For example, the DS-user terminal receives the first instruction message, where the first instruction message instructs the DS-user terminal to change the idle DRX period to 60 seconds, and therefore, according to the instruction message, the DS-user terminal changes the idle DRX period, which is originally configured by the network side for the DS-user terminal, to 60 seconds.

S506. The DS-user terminal communicates with the network-side device and the DM-user terminal according to a changed idle DRX period of the DS-user terminal.

In a subsequent communication process after the DS-user terminal changes the idle DRX period of the DS-user terminal, the DS-user terminal may communicate with the network-side device and the DM-user terminal according to the changed idle DRX period of the DS-user terminal.

S507. The DS-user terminal sends a first response message corresponding to the first instruction message to the DM-user terminal.

After the DS-user terminal completes changing the idle DRX period of the DS-user terminal, the DS-user terminal may send the first response message corresponding to the first instruction message to the DM-user terminal, so that the DM-user terminal can learn success of the DS-user terminal in changing the idle DRX period of the DS-user terminal.

S508. The DM-user terminal sends the first response message to the network-side device.

After the DM-user terminal receives the first response message reported by the DS-user terminal, if the DM-user terminal completes changing the idle DRX period of the DM-user terminal, the DM-user terminal sends the first response message to the network-side device, and therefore, according to the first response message, the network-side device can learn success of the DM-user terminal and the DS-user terminal in changing the idle DRX period.

Specially, the first response message sent by the DM-user terminal to the network-side device may include a state of success of the DM-user terminal in changing the idle DRX period of the DM-user terminal.

Optionally, the first response message may be used to indicate success of the DM-user terminal and the DS-user terminal in changing the idle DRX period according to the first instruction message; or may be used to indicate success of the DM-user terminal and the DS-user terminal in receiving the first instruction message and success of the DM-user terminal and the DS-user terminal in changing the idle DRX period according to the first instruction message, on which the present invention imposes no limitation.

S509. According to the first response message, the network-side device learns success of changing the idle DRX period.

After the network-side device receives the first response message sent by the DM-user terminal, the network-side device may learn, according to the first response message, success in changing the idle DRX period of the DM-user terminal and success in changing the idle DRX period of the DS-user terminal.

According to the synchronization method provided in the embodiment of the present invention, a DS-user terminal acquires a first timing offset, where the first timing offset is a difference between a start time point of receiving data by the DS-user terminal and a start time point of sending data by a DM-user terminal, or is a difference between a start time point of sending data by the DS-user terminal and a start time point of receiving data by a DM-user terminal, the start time point of sending data by the DM-user terminal is a start time point of sending data after the DM-user terminal is synchronized with a network-side device, and the start time point of receiving data by the DM-user terminal is a start time point of receiving data after the DM-user terminal is synchronized with the network-side device; and the DS-user terminal adjusts, according to the first timing offset, the start time point of receiving data by the DS-user terminal or the start time point of sending data by the DS-user terminal, so as to synchronize with the DM-user terminal and the network-side device. By means of this solution, after the DM-user terminal is synchronized with the network-side device, because the DS-user terminal can get synchronized with the network-side device by synchronizing with the DM-user terminal, synchronization without network coverage can be supported between the DS-user terminal and the network-side device.

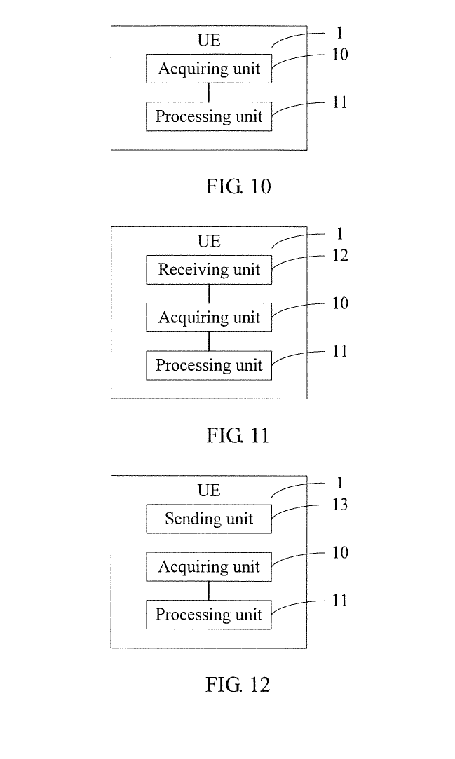

As shown in FIG. 10, an embodiment of the present invention provides a user terminal 1, where the user terminal 1 may include:

an acquiring unit 10, configured to acquire a first timing offset, where the first timing offset is a difference between a start time point of receiving data by the user tell final 1 and a start time point of sending data by a DM-user terminal, or is a difference between a start time point of sending data by the user terminal 1 and a start time point of receiving data by a DM-user terminal, the start time point of sending data by the DM-user terminal is a start time point of sending data after the DM-user terminal is synchronized with a network-side device, and the start time point of receiving data by the DM-user terminal is a start time point of receiving data after the DM-user terminal is synchronized with the network-side device; and

a processing unit 11, configured to adjust, according to the first timing offset acquired by the acquiring unit 10, the start time point of receiving data by the user terminal 1 or the start time point of sending data by the user terminal 1, so as to synchronize with the DM-user terminal and the network-side device.

Optionally, as shown in FIG. 11, the user terminal 1 further includes a receiving unit 12, where

the receiving unit 12 is configured to receive a first synchronization signal from the DM-user terminal when communication is performed between the user terminal 1 and the DM-user terminal in a D2D manner, where the first synchronization signal is used to synchronize the start time point of receiving data by the user terminal 1 with the start time point of sending data by the DM-user terminal, and the acquiring unit 10 is specifically configured to acquire the first timing offset according to the first synchronization signal received by the receiving unit 12, where the first synchronization signal is used to synthesize the start time point of receiving data by the user terminal 1 with the start time point of sending data by the DM-user terminal.

Optionally, as shown in FIG. 12, the user terminal 1 further includes a sending unit 13, where

the sending unit 13 is configured to, before the acquiring unit 10 acquires the first timing offset, send a synchronization signal to the DM-user terminal when communication is performed between the user terminal 1 and the DM-user terminal in a D2D manner, so that the DM-user terminal acquires the first timing offset according to the second synchronization signal and sends the first timing offset to the user terminal 1, where the second synchronization signal is used to synchronize the start time point of sending data by the user terminal 1 with the start time point of receiving data by the DM-user terminal.

Optionally, the acquiring unit 10 is specifically configured to perform calculation on the first synchronization signal received by the receiving unit 12, so as to obtain a first synchronization peak; and determine the first timing offset according to a time point corresponding to the first synchronization peak.

Optionally, the receiving unit 12 is specifically configured to receive the first synchronization signal from the DM-user terminal on a preset uplink time-frequency resource.

Optionally, the acquiring unit 10 is specifically configured to receive the first timing offset from the DM-user terminal on a preset uplink time-frequency resource.

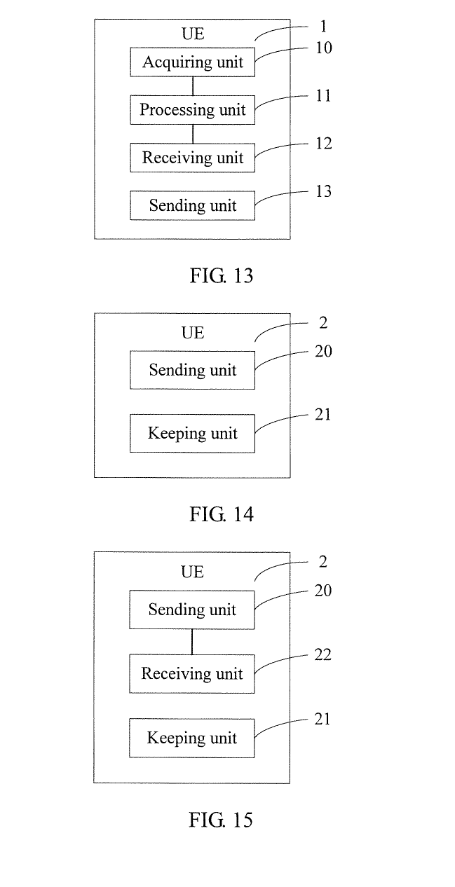

Optionally, as shown in FIG. 13, the user terminal 1 further includes a sending unit 13 and a receiving unit 12.

The receiving unit 12 is configured to receive a first instruction message from the DM-user terminal after the user terminal 1 is synchronized with the network-side device and the DM-user terminal, where the first instruction message is sent by the network-side device to the DM-user terminal, the first instruction message is used to instruct that an idle DRX period be changed, and the first instruction message includes a message type and a period value of the idle DRX period; the processing unit 11 is further configured to change the idle DRX period according to the first instruction message received by the receiving unit 12; and the sending unit 13 is configured to send, to the DM-user terminal, a first response message corresponding to the first instruction message received by the receiving unit 12, so that the DM-user terminal sends the first response message to the network-side device, and the network-side device learns, according to the first response message, success in changing the idle DRX period.

Optionally, the processing unit 11 is further configured to communicate with the DM-user terminal according to a changed idle DRX period.

The user terminal provided in the embodiment of the present invention acquires a first timing offset, where the first timing offset is a difference between a start time point of receiving data by the user terminal and a start time point of sending data by a DM-user terminal, or is a difference between a start time point of sending data by the user terminal and a start time point of receiving data by a DM-user terminal, the start time point of sending data by the DM-user terminal is a start time point of sending data after the DM-user terminal is synchronized with a network-side device, and the start time point of receiving data by the DM-user terminal is a start time point of receiving data after the DM-user terminal is synchronized with the network-side device; and the user terminal adjusts, according to the first timing offset, the start time point of receiving data by the user terminal or the start time point of sending data by the user terminal, so as to synchronize with the DM-user terminal and the network-side device. By means of this solution, after the DM-user terminal is synchronized with the network-side device, because the user terminal can get synchronized with the network-side device by synchronizing with the DM-user terminal, synchronization without network coverage can be supported between the user terminal and the network-side device.

As shown in FIG. 14, an embodiment of the present invention further provides a user terminal 2, where the user terminal 2 may include:

a sending unit 20, configured to send a first synchronization signal to a DS-user terminal when communication is performed between the DS-user terminal and the user terminal 2 in a D2D manner, where the first synchronization signal is used by the DS-user terminal to acquire a first timing offset according to the first synchronization signal, the first timing offset is a difference between a start time point of receiving data by the DS-user terminal and a start time point of sending data by the user terminal 2, and the start time point of sending data by the user terminal 2 is a start time point of sending data after the user terminal 2 is synchronized with a network-side device; and

a keeping unit 21, configured to keep synchronization with the DS-user terminal, where the synchronization is specifically that the DS-user terminal adjusts, according to the first timing offset, the start time point of receiving data by the DS-user terminal, so as to synchronize with the user terminal 2 and the network-side device.

Optionally, the sending unit 20 is specifically configured to send the first synchronization signal to the DS-user terminal on a preset uplink time-frequency resource.

Optionally, as shown in FIG. 15, the user terminal 2 further includes a receiving unit 22, where

the sending unit 20 is further configured to send a first instruction message to the DS-user terminal after the user terminal 2 is synchronized with the network-side device and the DS-user terminal, so that the DS-user terminal changes an idle DRX period according to the first instruction message, where the first instruction message is sent by the network-side device to the user terminal 2, the first instruction message is used to instruct that the idle DRX period be changed, and the first instruction message includes a message type and a period value of the idle DRX period; the receiving unit 22 is configured to receive a first response message that is from the DS-user terminal and corresponding to the first instruction message sent by the sending unit 20; and the sending unit 20 is further configured to send the first response message, which is received by the receiving unit 22, to the network-side device, so that the network-side device learns, according to the first response message, success in changing the idle DRX period.

The user terminal provided in the embodiment of the present invention may send a first synchronization signal to a DS-user terminal when communication is performed between the DS-user terminal and the user terminal in a D2D manner, where the first synchronization signal is used by the DS-user terminal to acquire a first timing offset according to the first synchronization signal, the first timing offset is a difference between a start time point of receiving data by the DS-user terminal and a start time point of sending data by the user terminal, and the start time point of sending data by the user terminal is the start time point of sending data after the user terminal is synchronized with a network-side device; and the user terminal keeps synchronization with the DS-user terminal, where the synchronization is specifically that the DS-user terminal adjusts, according to the first timing offset, the start time point of receiving data by the DS-user terminal, so as to synchronize with the user terminal and the network-side device. By means of this solution, after the user terminal is synchronized with the network-side device, because the DS-user terminal can get synchronized with the network-side device by synchronizing with the user terminal, synchronization without network coverage can be supported between the DS-user terminal and the network-side device.

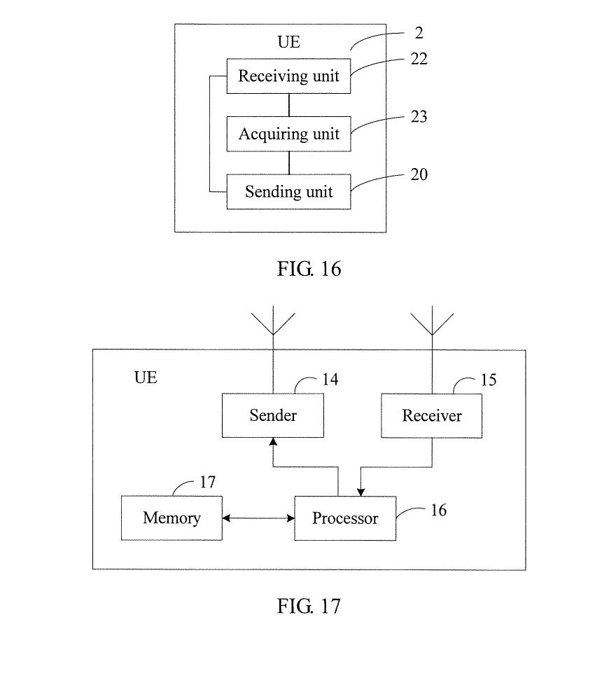

As shown in FIG. 16, an embodiment of the present invention further provides a user terminal 2, where the user terminal 2 may include:

a receiving unit 22, configured to receive a synchronization signal from a DS-user terminal when communication is performed between the DS-user terminal and the user terminal 2 in a D2D manner;

an acquiring unit 23, configured to acquire a first timing offset according to the synchronization signal received by the receiving unit 22 from the DS-user terminal, where the first timing offset is a difference between a start time point of sending data by the DS-user terminal and a start time point of receiving data by the user terminal 2, and the start time point of receiving data by the user terminal 2 is a start time point of receiving data after the user terminal 2 is synchronized with a network-side device; and

a sending unit 20, configured to send the first timing offset, which is acquired by the acquiring unit 23, to the DS-user terminal, where the first timing offset is used by the DS-user terminal to adjust, according to the first timing offset, the start time point of sending data by the DS-user terminal, so as to synchronize with the user terminal 2 and the network-side device.

Optionally, the acquiring unit 23 is specifically configured to perform calculation on the synchronization signal received by the receiving unit 22 from the DS-user terminal, so as to obtain a second synchronization peak; and determine the first timing offset according to a time point corresponding to the second synchronization peak.

Optionally, the sending unit 20 is specifically configured to send the first timing offset, which is acquired by the acquiring unit 23, to the DS-user terminal on a preset uplink time-frequency resource.

Optionally, the sending unit 20 is further configured to send a first instruction message to the DS-user terminal after the user terminal 2 is synchronized with the network-side device and the DS-user terminal, so that the DS-user terminal changes an idle DRX period according to the first instruction message, where the first instruction message is sent by the network-side device to the user terminal 2, the first instruction message is used to instruct that the idle DRX period be changed, and the first instruction message includes a message type and a period value of the idle DRX period; the receiving unit 22 is further configured to receive a first response message that is from the DS-user terminal and corresponding to the first instruction message sent by the sending unit 20; and the sending unit 20 is further configured to send the first response message, which is received by the receiving unit 22, to the network-side device, so that the network-side device learns, according to the first response message, success in changing the idle DRX period.

The user terminal provided in the embodiment of the present invention receives a synchronization signal from a DS-user terminal when communication is performed between the DS-user terminal and the user terminal in a D2D manner, and the user terminal acquires a first timing offset according to the synchronization signal received by the user terminal from the DS-user terminal, where the first timing offset is a difference between a start time point of sending data by the DS-user terminal and a start time point of receiving data by the user terminal, and the start time point of receiving data by the user terminal is the start time point of receiving data after the user terminal is synchronized with a network-side device; and the user terminal sends the first timing offset to the DS-user terminal, where the first timing offset is used by the DS-user terminal to adjust, according to the first timing offset, the start time point of sending data by the DS-user terminal, so as to synchronize with the user terminal and the network-side device. By means of this solution, after the user terminal is synchronized with the network-side device, because the DS-user terminal can get synchronized with the network-side device by synchronizing with the user terminal, synchronization without network coverage can be supported between the DS-user terminal and the network-side device.

As shown in FIG. 17, an embodiment of the present invention provides a user terminal, including a sender 14, a receiver 15, a processor 16, and a memory 17.

The sender 14 may be configured to send a communication signal to another user terminal, and specially, if the user terminal needs to communicate with the other user terminal, the sender 14 may send communication data to the other user terminal.

The receiver 15 may be configured to receive the communication signal from the other user terminal, and specially, if the user terminal needs to communicate with the other user terminal, the receiver 15 may receive communication data from the other user terminal.

The processor 16 is a control and processing center of the user terminal, and, by running a software program stored in the memory 17 and invoking and processing the data stored in the memory 17, controls the user terminal to receive and send a signal and implement other functions of the user terminal.

The memory 17 may be configured to store a software program and data, so that the processor 16 may implement signal receiving and sending and other functions of the user terminal by running the software program stored in the memory 17.

Specifically, the processor 16 may be configured to acquire a first timing offset, and adjust, according to the first timing offset, the start time point of receiving data by the user terminal or the start time point of sending data by the user terminal, so as to synchronize with a DM-user terminal and a network-side device, where the first timing offset is a difference between a start time point of receiving data by the user terminal and a start time point of sending data by the DM-user terminal, or is a difference between a start time point of sending data by the user terminal and a start time point of receiving data by the DM-user terminal, the start time point of sending data by the DM-user terminal is a start time point of sending data after the DM-user terminal is synchronized with the network-side device, and the start time point of receiving data by the DM-user terminal is a start time point of receiving data after the DM-user terminal is synchronized with the network-side device. The memory 17 may be configured to store the first timing offset and control the user terminal to execute the software program in the foregoing step, and therefore, by executing the software program, the processor 16 may invoke the first timing offset to complete the foregoing step.

Optionally, the receiver 15 is configured to receive a first synchronization signal from the DM-user terminal when communication is performed between the user terminal and the DM-user terminal in a D2D manner, where the first synchronization signal is used to synchronize the start time point of receiving data by the user terminal with the start time point of sending data by the DM-user terminal; and the processor 16 is specifically configured to acquire the first timing offset according to the first synchronization signal received by the receiver 15.

Optionally, the sender 14 is configured to, before the processor 16 acquires the first timing offset, send a second synchronization signal to the DM-user terminal when communication is performed between the user terminal and the DM-user terminal in a D2D manner, so that the DM-user terminal acquires the first timing offset according to the second synchronization signal and sends the first timing offset to the user terminal, where the second synchronization signal is used to synchronize the start time point of sending data by the user terminal with the start time point of receiving data by the DM-user terminal.

Optionally, the processor 16 is specifically configured to perform calculation on the first synchronization signal received by the receiver 15, so as to obtain a first synchronization peak; and determine the first timing offset according to a time point corresponding to the first synchronization peak.

Optionally, the receiver 15 is specifically configured to receive the first synchronization signal from the DM-user terminal on a preset uplink time-frequency resource.

Optionally, the receiver 15 is configured to receive the first timing offset from the DM-user terminal on a preset uplink time-frequency resource.

Optionally, the receiver 15 is configured to receive a first instruction message from the DM-user terminal after the user terminal is synchronized with the network-side device and the DM-user terminal, where the first instruction message is sent by the network-side device to the DM-user terminal, the first instruction message is used to instruct that an idle DRX period be changed, and the first instruction message includes a message type and a period value of the idle DRX period; the processor 16 is further configured to change the idle DRX period according to the first instruction message received by the receiver 15; and the sender 14 is configured to send a first response message, which is corresponding to the first instruction message received by the receiver 15, to the DM-user terminal, so that the DM-user terminal sends the first response message to the network-side device, and the network-side device learns, according to the first response message, success in changing the idle DRX period.

Optionally, the processor 16 is further configured to communicate with the DM-user terminal according to a changed idle DRX period.

The user terminal provided in the embodiment of the present invention acquires a first timing offset, where the first timing offset is a difference between a start time point of receiving data by the user terminal and a start time point of sending data by a DM-user terminal, or is a difference between a start time point of sending data by the user terminal and a start time point of receiving data by a DM-user terminal, the start time point of sending data by the DM-user terminal is a start time point of sending data after the DM-user terminal is synchronized with a network-side device, and the start time point of receiving data by the DM-user terminal is a start time point of receiving data after the DM-user terminal is synchronized with the network-side device; and the user terminal adjusts, according to the first timing offset, the start time point of receiving data by the user terminal or the start time point of sending data by the user terminal, so as to synchronize with the DM-user terminal and the network-side device. By means of this solution, after the DM-user terminal is synchronized with the network-side device, because the user terminal can get synchronized with the network-side device by synchronizing with the DM-user terminal, synchronization without network coverage can be supported between the user terminal and the network-side device.

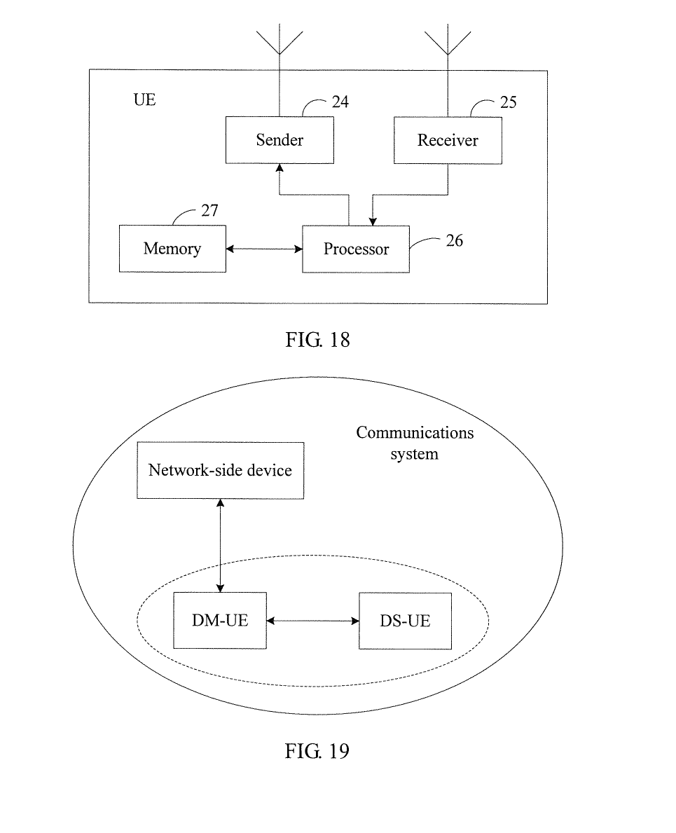

As shown in FIG. 18, an embodiment of the present invention provides a user terminal, including a sender 24, a receiver 25, a processor 26, and a memory 27.

The sender 24 may be configured to send an uplink signal to a network-side device, and specially, if the user terminal needs to communicate with the network-side device, the sender 24 may send uplink communication data to the network-side device.

The receiver 25 may be configured to receive a downlink signal from the network-side device, and specially, if the user terminal needs to communicate with the network-side device, the receiver 25 may receive downlink communication data from the network-side device.

The processor 26 is a control and processing center of the user terminal, and, by running a software program stored in the memory 27 and invoking and processing the data stored in the memory 27, controls the user terminal to receive and send a signal and implement other functions of the user terminal.

The memory 27 may be configured to store a software program and data, so that the processor 26 may implement signal receiving and sending and other functions of the user terminal by running the software program stored in the memory 27.

Specifically, the sender 24 may be configured to send a first synchronization signal to a DS-user terminal when communication is performed between the DS-user terminal and the user terminal in a D2D manner, where the first synchronization signal is used by the DS-user terminal to acquire a first timing offset according to the first synchronization signal, the first timing offset is a difference between a start time point of receiving data by the DS-user terminal and a start time point of sending data by the user terminal, and the start time point of sending data by the user terminal is a start time point of sending data after the user terminal is synchronized with a network-side device; the processor 26 is configured to keep synchronization with the DS-user terminal, where the synchronization is specifically that the DS-user terminal adjusts, according to the first timing offset, the start time point of receiving data by the DS-user terminal, so as to synchronize with the user terminal and the network-side device; and the memory 27 may be configured to store software code of the first synchronization signal and control the user terminal to execute the software program in the foregoing step, and therefore, by executing the software program, the processor 26 may invoke the software code to complete the foregoing step.

Optionally, the sender 24 is specifically configured to send the first synchronization signal to the DS-user terminal on a preset uplink time-frequency resource.

Optionally, the sender 24 is further configured to send a first instruction message to the DS-user terminal after the user terminal is synchronized with the network-side device and the DS-user terminal, so that the DS-user terminal changes an idle DRX period according to the first instruction message, where the first instruction message is sent by the network-side device to the user terminal, the first instruction message is used to instruct that the idle DRX period be changed, and the first instruction message includes a message type and a period value of the idle DRX period; the receiver 25 is configured to receive a first response message that is from the DS-user terminal and corresponding to the first instruction message sent by the sender 24; and the sender 24 is further configured to send the first response message, which is received by the receiver 25, to the network-side device, so that the network-side device learns, according to the first response message, success in changing the idle DRX period.

The user terminal provided in the embodiment of the present invention may send a first synchronization signal to a DS-user terminal when communication is performed between the DS-user terminal and the user terminal in a D2D manner, where the first synchronization signal is used by the DS-user terminal to acquire a first timing offset according to the first synchronization signal, the first timing offset is a difference between a start time point of receiving data by the DS-user terminal and a start time point of sending data by the user terminal, and the start time point of sending data by the user terminal is the start time point of sending data after the user terminal is synchronized with a network-side device; and the user terminal keeps synchronization with the DS-user terminal, where the synchronization is specifically that the DS-user terminal adjusts, according to the first timing offset, the start time point of receiving data by the DS-user terminal, so as to synchronize with the user terminal and the network-side device. By means of this solution, after the user terminal is synchronized with the network-side device, because the DS-user terminal can get synchronized with the network-side device by synchronizing with the user terminal, synchronization without network coverage can be supported between the DS-user terminal and the network-side device.

As shown in FIG. 18, an embodiment of the present invention provides a user terminal, including a sender 24, a receiver 25, a processor 26, and a memory 27.

Specifically, the receiver 25 may be configured to receive a synchronization signal from a DS-user terminal when communication is performed between the DS-user terminal and the user terminal in a D2D manner; the processor 26 may be configured to acquire a first timing offset according to the synchronization signal received by the receiver 25 from the DS-user terminal, where the first timing offset is a difference between a start time point of sending data by the DS-user terminal and a start time point of receiving data by the user terminal, and the start time point of receiving data by the user terminal is a start time point of receiving data after the user terminal is synchronized with a network-side device; the sender 24 may be configured to send the first timing offset, which is acquired by the processor 26, to the DS-user terminal, where the first timing offset is used by the DS-user terminal to adjust, according to the first timing offset, the start time point of sending data by the DS-user terminal, so as to synchronize with the user terminal and the network-side device; and the memory 27 may be configured to store software code of the second synchronization signal and the first timing offset, and control the user terminal to execute the software program in the foregoing step, and therefore, by executing the software program, the processor 26 may invoke the software code to complete the foregoing step.

Optionally, the processor 26 is specifically configured to perform calculation on the synchronization signal received by the receiver 25 from the DS-user terminal, so as to obtain a second synchronization peak; and determine the first timing offset according to a time point corresponding to the second synchronization peak.

Optionally, the sender 24 is specifically configured to send the first timing offset, which is acquired by the processor 26, to the DS-user terminal on a preset uplink time-frequency resource.

Optionally, the sender 24 is further configured to send a first instruction message to the DS-user terminal after the user terminal is synchronized with the network-side device and the DS-user terminal, so that the DS-user terminal changes an idle DRX period according to the first instruction message, where the first instruction message is sent by the network-side device to the user terminal, the first instruction message is used to instruct that the idle DRX period be changed, and the first instruction message includes a message type and a period value of the idle DRX period; the receiver 25 is further configured to receive a first response message that is from the DS-user terminal and corresponding to the first instruction message sent by the sender 24; and the sender 24 is further configured to send the first response message, which is received by the receiver 25, to the network-side device, so that the network-side device learns, according to the first response message, success in changing the idle DRX period.

The user terminal provided in the embodiment of the present invention receives a synchronization signal from a DS-user terminal when communication is performed between the DS-user terminal and the user terminal in a D2D manner, and the user terminal acquires a first timing offset according to the synchronization signal received by the user terminal from the DS-user terminal, where the first timing offset is a difference between a start time point of sending data by the DS-user terminal and a start time point of receiving data by the user terminal, and the start time point of receiving data by the user terminal is the start time point of receiving data after the user terminal is synchronized with a network-side device; and the user terminal sends the first timing offset to the DS-user terminal, where the first timing offset is used by the DS-user terminal to adjust, according to the first timing offset, the start time point of sending data by the DS-user terminal, so as to synchronize with the user terminal and the network-side device. By means of this solution, after the user terminal is synchronized with the network-side device, because the DS-user terminal can get synchronized with the network-side device by synchronizing with the user terminal, synchronization without network coverage can be supported between the DS-user terminal and the network-side device.

As shown in FIG. 19, an embodiment of the present invention provides a communications system, including a network-side device, a user terminal used as a DM-user terminal, and a user terminal used as a DS-user terminal.

According to the communications system provided in the embodiment of the present invention, a DS-user terminal acquires a first timing offset, where the first timing offset is a difference between a start time point of receiving data by the DS-user terminal and a start time point of sending data by a DM-user terminal, or is a difference between a start time point of sending data by the DS-user terminal and a start time point of receiving data by a DM-user terminal, the start time point of sending data by the DM-user terminal is a start time point of sending data after the DM-user terminal is synchronized with a network-side device, and the start time point of receiving data by the DM-user terminal is a start time point of receiving data after the DM-user terminal is synchronized with the network-side device; and the DS-user terminal adjusts, according to the first timing offset, the start time point of receiving data by the DS-user terminal or the start time point of sending data by the DS-user terminal, so as to synchronize with the DM-user terminal and the network-side device. By means of this solution, after the DM-user terminal is synchronized with the network-side device, because the DS-user terminal can get synchronized with the network-side device by synchronizing with the DM-user terminal, synchronization without network coverage can be supported between the DS-user terminal and the network-side device.

It may be clearly understood by a person skilled in the art that, for the purpose of convenient and brief description, division of the foregoing functional modules is taken as an example for illustration. In actual application, the foregoing functions can be allocated to different functional modules and implemented according to a requirement, that is, an inner structure of an apparatus is divided into different functional modules to implement all or some of the functions described above. For a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or some of the technical solutions may be implemented in the form of a software product. The computer software product is stored in a storage medium and includes several instructions for instructing a computer device (which may be a personal computer, a server, or a network device) or a processor (processor) to perform all or some of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A synchronization method, comprising:
acquiring, by a device-to-device secondary user terminal (DS-user terminal), a first timing offset, wherein the first timing offset comprises,
a difference between a start time point of receiving data by the DS-user terminal and a start time point of sending data by a device-to-device master user terminal (DM-user terminal), wherein the start time point of sending data by the DM-user terminal is a start time point of sending data after the DM-user terminal is synchronized with a network-side device, or
a difference between a start time point of sending data by the DS-user terminal and a start time point of receiving data by a DM-user terminal, wherein the start time point of receiving data by the DM-user terminal is a start time point of receiving data after the DM-user terminal is synchronized with the network-side device; and
adjusting, by the DS-user terminal according to the first timing offset, the start time point of receiving data by the DS-user terminal or the start time point of sending data by the DS-user terminal, so as to synchronize with the DM-user terminal and the network-side device.

2. The synchronization method according to claim 1, wherein acquiring, by a device-to-device secondary user terminal (DS-user terminal), a first timing offset comprises:
receiving, by the DS-user terminal, a first synchronization signal from the DM-user terminal when communication is performed between the DS-user terminal and the DM-user terminal in a device-to-device (D2D) manner, wherein the first synchronization signal is used to synchronize the start time point of receiving data by the DS-user terminal with the start time point of sending data by the DM-user terminal; and
acquiring, by the DS-user terminal, the first timing offset according to the first synchronization signal.

3. The synchronization method according to claim 1, wherein before acquiring, by a device-to-device secondary user terminal (DS-user terminal), a first timing offset, the method further comprises:
sending, by the DS-user terminal, a second synchronization signal to the DM-user terminal when communication is performed between the DS-user terminal and the DM-user terminal in a device-to-device (D2D) manner, so that the DM-user terminal acquires the first timing offset according to the second synchronization signal and sends the first timing offset to the DS-user terminal, wherein the second synchronization signal is used to synchronize the start time point of sending data by the DS-user terminal with the start time point of receiving data by the DM-user terminal.

4. The synchronization method according to claim 2, wherein receiving, by the DS-user terminal, a first synchronization signal from the DM-user terminal comprises:
receiving, by the DS-user terminal, the first synchronization signal from the DM-user terminal on a preset uplink time-frequency resource.

5. The synchronization method according to claim 3, wherein acquiring, by a device-to-device secondary user terminal DS-user terminal, a first timing offset comprises:
receiving, by the DS-user terminal, the first timing offset from the DM-user terminal on a preset uplink time-frequency resource.

6. The synchronization method according to claim 1, wherein after synchronizing, by the DS-user terminal, with the network-side device and the DM-user terminal, the method further comprises:
receiving, by the DS-user terminal, a first instruction message from the DM-user terminal, wherein the first instruction message is sent by the network-side device to the DM-user terminal, the first instruction message is used to instruct that an idle discontinuous reception (DRX) period be changed, and the first instruction message comprises a message type and a period value of the idle DRX period;
changing, by the DS-user terminal, the idle DRX period according to the first instruction message; and
sending, by the DS-user terminal, a first response message corresponding to the first instruction message to the DM-user terminal for sending the first response message to the network-side device, and the network-side device learns, according to the first response message, success in changing the idle DRX period.

7. The synchronization method according to claim 6, wherein after changing, by the DS-user terminal, the idle DRX period according to the first instruction message, the method further comprises:
communicating, by the DS-user terminal, with the DM-user terminal according to a changed idle DRX period.

8. A user terminal, comprising:
a processor, configured to acquire a first timing offset, and adjust, according to the first timing offset, a start time point of receiving data by the user terminal or a start time point of sending data by the user terminal, so as to synchronize with a DM-user terminal and a network-side device, wherein the first timing offset comprises:
a difference between a start time point of receiving data by the user terminal and a start time point of sending data by the DM-user terminal, wherein the start time point of sending data by the DM-user terminal is a start time point of sending data after the DM-user terminal is synchronized with the network-side device; or
a difference between a start time point of sending data by the user terminal and a start time point of receiving data by the DM-user terminal, wherein the start time point of receiving data by the DM-user terminal is a start time point of receiving data after the DM-user terminal is synchronized with the network-side device.

9. The user terminal according to claim 8, wherein:
the user terminal further comprises a receiver configured to: receive a first synchronization signal from the DM-user terminal when communication is performed between the user terminal and the DM-user terminal in a device-to-device (D2D) manner, wherein the first synchronization signal is used to synchronize the start time point of receiving data by the user terminal with the start time point of sending data by the DM-user terminal; and
the processor is configured to: acquire the first timing offset according to the first synchronization signal received by the receiver.

10. The user terminal according to claim 8, wherein the user terminal further comprises:
a sender configured to, before the processor acquires the first timing offset, send a second synchronization signal to the DM-user terminal when communication is performed between the user terminal and the DM-user terminal in a device-to-device (D2D) manner for acquiring the first timing offset according to the second synchronization signal and sends the first timing offset to the user terminal, wherein the second synchronization signal is used to synchronize the start time point of sending data by the user terminal with the start time point of receiving data by the DM-user terminal.

11. The user terminal according to claim 9, wherein the processor is configured to:
perform calculation on the first synchronization signal received by the receiver, so as to obtain a first synchronization peak; and
determine the first timing offset according to a time point corresponding to the first synchronization peak.

12. The user terminal according to claim 9, wherein the receiver is configured to: receive the first synchronization signal from the DM-user terminal on a preset uplink time-frequency resource.

13. The user terminal according to claim 10, wherein the user terminal further comprises:
a receiver configured to receive the first timing offset from the DM-user terminal on a preset uplink time-frequency resource.

14. The user terminal according to claim 8, wherein the user terminal further comprises:
a receiver configured to: receive a first instruction message from the DM-user terminal after the user terminal is synchronized with the network-side device and the DM-user terminal, wherein the first instruction message is sent by the network-side device to the DM-user terminal, the first instruction message is used to instruct that an idle discontinuous reception (DRX) period be changed, and the first instruction message comprises a message type and a period value of the idle DRX period;
wherein the processor is further configured to change the idle DRX period according to the first instruction message received by the receiver; and
a sender configured to: send a first response message, which is corresponding to the first instruction message received by the receiver, to the DM-user terminal for sending the first response message to the network-side device, and the network-side device learns, according to the first response message, success in changing the idle DRX period.

15. The user terminal according to claim 14, wherein the processor is further configured to: communicate with the DM-user terminal according to a changed idle DRX period.

16. A user terminal, comprising:
a sender, configured to send a first synchronization signal to a DS-user terminal when communication is performed between the DS-user terminal and the user terminal in a device-to-device (D2D) manner, wherein the first synchronization signal is used by the DS-user terminal to acquire a first timing offset according to the first synchronization signal, the first timing offset is a difference between a start time point of receiving data by the DS-user terminal and a start time point of sending data by the user terminal, and the start time point of sending data by the user terminal is a start time point of sending data after the user terminal is synchronized with a network-side device; and
a processor, configured to keep synchronization with the DS-user terminal, wherein the synchronization is specifically that the DS-user terminal adjusts, according to the first timing offset, the start time point of receiving data by the DS-user terminal, so as to synchronize with the user terminal and the network-side device.

17. The user terminal according to claim 16, wherein the sender is configured to: send the first synchronization signal to the DS-user terminal on a preset uplink time-frequency resource.

18. The user terminal according to claim 16, wherein:
the user terminal further comprises a receiver;
the sender is further configured to send a first instruction message to the DS-user terminal after the user terminal is synchronized with the network-side device and the DS-user terminal for changing an idle discontinuous reception (DRX) period according to the first instruction message, wherein the first instruction message is sent by the network-side device to the user terminal, the first instruction message is used to instruct that the idle DRX period be changed, and the first instruction message comprises a message type and a period value of the idle DRX period;
the receiver is configured to receive a first response message that is from the DS-user terminal and corresponding to the first instruction message sent by the sender; and
the sender is further configured to send the first response message, which is received by the receiver, to the network-side device for learning, according to the first response message, success in changing the idle DRX period.

19. A user terminal, comprising:
a receiver, configured to receive a synchronization signal from a DS-user terminal when communication is performed between the DS-user terminal and the user terminal in a device-to-device (D2D) manner;
a processor, configured to acquire a first timing offset according to the synchronization signal received by the receiver from the DS-user terminal, wherein the first timing offset is a difference between a start time point of sending data by the DS-user terminal and a start time point of receiving data by the user terminal, and the start time point of receiving data by the user terminal is a start time point of receiving data after the user terminal is synchronized with a network-side device; and
a sender, configured to send the first timing offset, which is acquired by the processor, to the DS-user terminal, wherein the first timing offset is used by the DS-user terminal to adjust, according to the first timing offset, the start time point of sending data by the DS-user terminal, so as to synchronize with the user terminal and the network-side device.

20. The user terminal according to claim 19, wherein the processor is configured to:
perform calculation on the synchronization signal received by the receiver from the DS-user terminal, so as to obtain a second synchronization peak; and
determine the first timing offset according to a time point corresponding to the second synchronization peak.
